(19) United States
(12) Patent Application Publication
(10) Pub. No.: US 2009/0204427 A1
(43) Pub. Date: Aug. 13, 2009

(54) Adaptable compositions of health information

(76) Inventor: Anuthep Benja-Athon, New York, NY (US)

Correspondence Address: ANUTHEP BENJA-ATHON, 210 E. 36th Street, New York, NY, 10016, US

(21) Appl. No.: 12/381,654

(22) Filed: Mar. 16, 2009

Related U.S. Application Data
(63) Continuation-in-part of application No. 12/321,141, filed on Jan. 16, 2009.
Application No. 12/321,141 is a continuation-in-part of application No. 12/069,409, filed on Feb. 11, 2008.
Application No. 12/069,409 is a continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/716,062, filed on Mar. 9, 2007.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006.
Application No. 11/637,662 is a continuation-in-part of application No. 11/599,847, filed on Nov. 16, 2006.
Application No. 11/599,847 is a continuation-in-part of application No. 11/431,046, filed on May 10, 2006.
Application No. 11/431,046 is a continuation-in-part of application No. 11/543,895, filed on Oct. 6, 2006.
Application No. 11/543,895 is a continuation-in-part of application No. 11/523,945, filed on Sep. 21, 2006.
Application No. 11/523,945 is a continuation-in-part of application No. 11/510,820, filed on Aug. 28, 2006.
Application No. 11/510,820 is a continuation-in-part of application No. 11/477,121, filed on Jun. 29, 2006.
Application No. 11/477,121 is a continuation-in-part of application No. 11/114,763, filed on Apr. 27, 2005.
Application No. 11/114,763 is a continuation-in-part of application No. 11/196,823, filed on Aug. 4, 2005.
Application No. 11/196,823 is a continuation-in-part of application No. 11/973,866, filed on Oct. 11, 2007.
Application No. 11/973,866 is a continuation-in-part of application No. 11/293,689, filed on Dec. 5, 2005.
Application No. 11/293,689 is a continuation-in-part of application No. 11/150,878, filed on Jun. 13, 2005.
Application No. 11/150,878 is a continuation-in-part of application No. 11/074,236, filed on Mar. 7, 2005.
Application No. 11/074,236 is a continuation-in-part of application No. 11/022,410, filed on Dec. 27, 2004, now abandoned.

(51) Int. Cl. G06Q 50/00

(52) U.S. Cl. 705/2

(57) ABSTRACT

The adaptable compositions of information and data on health, health-care and health-care services generate by physicians and enable by an innovative computer program and software to increase physicians' efficiency of information and data management.

This application is a continuation-in-part of Ser. No. 12/321,141 entitled the Best system of health and health-care data management filed Jan. 16, 2009 which is a continuation-in-part of Ser. No. 12/069,409 entitled the Filing of Health and Health-care data filed Feb. 11, 2008, continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007, a continuation-in-part of Ser. No. 11/637,662 entitled A vital hierarchy of data on diseases filed Dec. 13, 2006, a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006, a continuation-in-part of Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of Ser. No. 11/114,763 entitled A system of influencing health-care utilizations filed Apr. 27, 2005, a continuation-in-part of Ser. No. 11/196,823 entitled Routing of health information files filed Aug. 4, 2005, a continuation-in-part of Ser. No. 11/973,866 entitled An intelligent system of speech recognizing physicians' data, a continuation-in-part of Ser. No. 11/293,689 entitled A system of conserving health-care buyers' resources filed Dec. 5, 2005, a continuation-in-part of Ser. No. 11/150,878 entitled Physicians' optimal management of health information filed Jun. 13, 2005, a continuation-in-part of Ser. No. 11/074,236 entitled A system of management of health-care resources filed Mar. 7, 2005 and a continuation-in-part of Ser. No. 11/022,410 entitled Physicians' way of information productions filed Dec. 27, 2004.

### FIELD OF INVENTION

Adaptable compositions of information and data on health and health-care.

### BACKGROUND OF THE INVENTION

The concepts of and means for generating and managing health and health-care data and information on patients by physicians and the incorporations into and relations of said data and information to the larger health and health-care data and information generated by patients and physicians are taught in said pending patent applications.

The system and method of using the means for filing, relating, managing and expanding health, health-care and health-care-service information and data on patients and physicians and for effecting the associations, incorporations, relations and managements of said information and data by said patients, physicians and computer servers were heretofore either not achieved, described or not detailed. Said pending patent applications provide a system and a method to achieve the objectives and goals described herein.

However, the present invention—an advance to said pending patent applications—provides a versatile and adaptable system of compositions on information and data on diagnoses, diseases, disorders and related information and data on health, health-care and health-care services and method of managing said information and data to enhance or optimize the accuracy of the recording of said information and data, to assist with and/or facilitate the medical decision makings and reduce or eliminate errors in decision makings of physicians, to improve and increase the efficiency of the processes of generating and recording health and health-care information and data, to expedite the process or processes of entering and recording of said information and data into said database or databases by physicians and to reduce the repetitive efforts of physicians' productions of same or similar said information and data and relating errors.

The present invention together with said pending patent applications are the only means and solution for solving the current health and health-care woes affecting all Americans and, consequently, they produce the best health-care system the world ever known and have and the benefits for billions of people and humanity are immense.

### SUMMARY OF THE INVENTION

The present invention provides a versatile and adaptable compositions of information and data on diagnoses of diseases and disorders and health, health-care and health-care services on and relating to said diagnoses of diseases and disorders for physicians for concordant management of information and data on health, health-care and health-care services and a method of managing information and data on medicine, surgery, health, health-care and health-care services by physician and is a system of adaptable compositions on information and data on health, health-care and health-care services wherein the contents of said compositions are derived from information and data on diagnoses, diseases, disorders, health, health-care and health-care services generated by physicians wherein said information and data are submitted, processed, related, stored, pooled and compiled in the database or databases of the computer servers wherein said contents of said compositions are repetitively composed and/or compiled from said submitted, processed, related and compiled information and data in said database or databases by said innovative computer program and software wherein said compositions are repetitively retrieved from said database or databases and the information and data and contents of said compositions are repetitively manipulated, modified, edited and/or improved by physicians to suit and be used by said physician composers and submitted, processed, related, stored, compiled in said database or databases to enhance or optimize the practice of medicine by physicians.

### BRIEF DESCRIPTION OF THE DRAWINGS

FIG. 1—a schematics of interactive electronic templates

FIG. 2—entry of information and data into templates

FIG. 3—improvements of information and data in templates

FIG. 4—an interactive means for physicians' manipulation of information and data

FIG. 5—an interactive means for physicians' manipulation of information and data

FIG. 6—repetitive manipulations of information and data

FIG. 7—entry of information and data into database or databases by a physician

FIG. 8—entry of information and data into database or databases by a physician

FIG. 9—entry of information and data into database or databases by a physician

FIG. 10—a schematics of an abbreviated interactive and adaptable composition

FIG. 11—an interactive means for physicians' manipulation of information and data

FIG. 12—a schematics of interactive templates used by physicians and patients

FIG. 13—a schematics of electronic templates use by a patient owner and physicians

FIG. 14—a schematics of representing an improvement of information and data

### BRIEF DESCRIPTION OF THE PREFERRED EMBODIMENTS

The present invention provides adaptable compositions of information and data on diagnoses of diseases and disorders and health, health-care and health-care services on and relating to said diagnoses of diseases and disorders for physicians for concordant management of information and data on health, health-care and health-care services wherein said adaptable compositions are generated, used and enlarged by physicians of different and diverse medical and surgical specialties or practices and by an innovative computer program and software invented and created by the present patent applicant.

Information and data on diagnoses of diseases and disorders and health, health-care and health-care services on and relating to said diagnoses, diseases and disorders are generated by said physicians using computers and/or mobile communication devices, such as, but not limited to, mobile cordless phones and said information and data are submitted by physicians via the Internet to the database or databases generate by commercially available computer programs such as, but not limited to, Microsoft SQL Server or MySQL and the like in the commercially available computer server or computer servers operating Microsoft Windows Server, Internet Explorer, Web browsers, Web server, Apache, Microsoft IIS, Visual Studio and .Net and Microsoft programs and software including Wordpad, Notepad and the like in a network or networks of computer servers, computers and portable communication devices and also said innovative computer program and software invented support by said commercially available computer programs and software and other computer programs and software including programs, languages and codes and their derivatives which are commonly and routinely used by computer engineers and programmers such as, but not limited to, PHP, JAVA, Java Script, AJAX, HTML and the like and related and their derivatives.

### First Stage—I. Individual Physicians' Compositions of Data

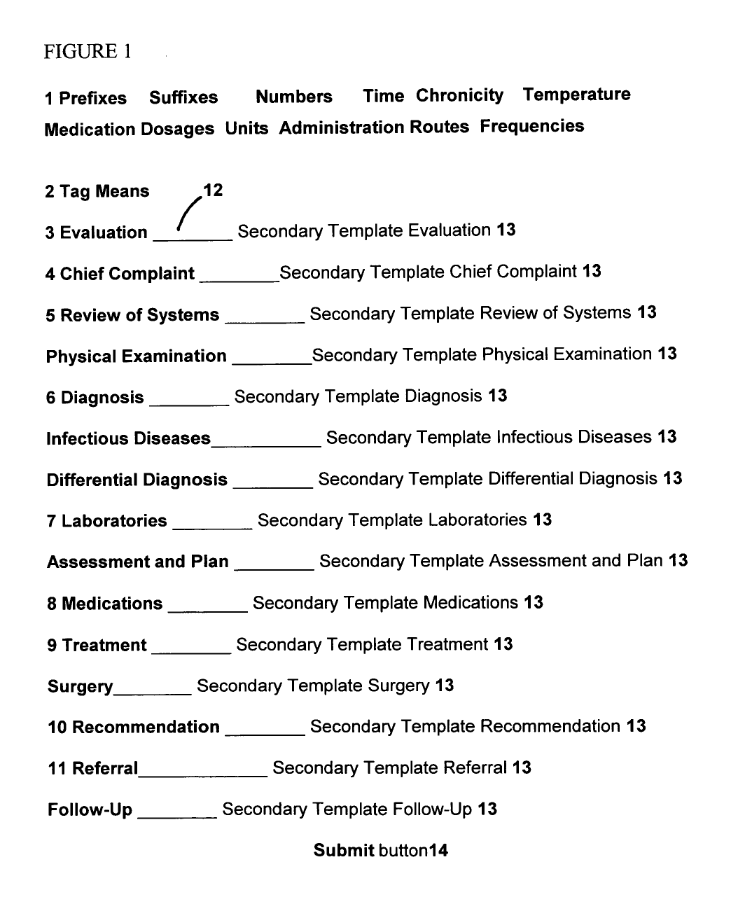

In one of the preferred embodiments of the present invention, physicians of about 85 medical and surgical specialties or practices using computers and/or mobile communication devices from diverse and different locations access said computer server or servers via the Internet. Per routine, said physicians login and complete subsequent routine processes and security for access the database or databases of said computer server or servers. In said computer server or servers, the first computer program means for generating, relating, processing, compiling and storing information and data on diagnoses, diseases, disorders, health, health-care and health-care services present to said physicians interactive electronic templates for enabling physicians to view, organize and enter information and data on or relating to diagnoses of diseases and disorders and health, health-care and health-care services on and relating to said diagnoses of diseases and disorders. For example, said Web browser enables the displays of interactive electronic templates to said physicians for viewing, manipulating, editing, organizing, improving, entering and submitting to said database or databases information and data on or relating to diagnoses of diseases and disorders and health, health-care and health-care services on and relating to said diagnoses of diseases and disorders in the schematics represent by figures infra. FIG. 1 schematically represents a primary interactive electronic template and a secondary interactive electronic template 13 including interactive graphics infra view and use by physicians by and interactive with physicians all over America and other nations and computer software and program means for effecting said processes and products and relating the contents comprising diagnoses, diseases, disorders and relating information and data on health, health-care and health-care services in interactive electronic templates enable by said computer programs and software and on said viewing screens.

FIG. 1 schematically represents one of said templates wherein the first two rows of bold words and terms comprising 1 Prefixes, Suffixes, Numbers, Time, Medication Dosages, Units, AdministrationRoutes and Frequencies represent tens to hundreds of interactive prefixes and suffixes—support by said computer software and program and JAVA Script—such as, but not limited to, sidedness such as left, right, bilateral, contralateral, 1, 2, 3, 4, 5, 6, 7, 8, 9, 0, milligrams, c.c., oral, parenteral, bid, tid, qid and the like, etc. applicable to be related or entered with the contents entered to the right of said word and term headers. The 2 Tag Means tags or identifies said information and data such as, but not limited to, individual physicians' and patients' identities and diagnoses relating to said information and data. The Submit button 14 enables individual physicians using said information and data to submit said information and data into said database or databases.

In this example of one of the preferred embodiments of the present invention as illustrated in FIG. 1, each “” 12 in FIG. 1 represents an interactive box or space in said interactive electronic templates—blank or empty in the schematics in FIG. 1—which enable physicians using computers and/or mobile communication devices in different and diverse locations to enter information and data 15 on or relating to individual DIAGNOSES of diseases and disorders and on and relating health, health-care and health-care services provided by physicians. Furthermore, as schematically represent in FIG. 1, in this preferred embodiment of the present invention, link and relate to said word and term headers or headings—3 Evaluation, 4 Chief Complaint, 5 Review of Systems, Physical Examination, 6 Diagnosis, Infectious Diseases, Differential Diagnosis, 7 Laboratories such as, but not limited to, Imaging, Body Fluid Tests and Tissues Examination, Assessment and Plan, 8 Medications, 9 Treatment, Surgery, 10 Recommendation, 11 Referral and Follow-up—are numerous interactive electronic Secondary Templates 13 each of which relates to said word and term headers and each said Secondary Template 13—when clicked—shows interactive pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices. Moreover, interactive graphics such as, but not limited to, U.S. Pat. No. 6,132,218 which can be clicked to present pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices viewable and useable by said physicians. Said interactive pop-up and/or drop-down lists and/or menus and interactive graphics are used in interactive electronic templates supra and infra for clicking and entering said information and data already related, compiled and stored in said database or databases wherein said information and data are retrieved and used—and less keyboarding—by physicians.

It is to be understood that information and data 15 described supra and infra appropriately apply to all headers or headings, such as, but not limited to, 3 Evaluation, 4 Chief Complaint, 5 Review of Systems, Physical Examination, 6 Diagnosis, Infectious Diseases, Differential Diagnosis, 7 Laboratories such as, but not limited to, Imaging, Body Fluid Tests and Tissues Examination, Assessment and Plan, 8 Medications, 9 Treatment, Surgery, 10 Recommendation, 11 Referral and Follow-up.

Therefore, physicians of about 85 medical and surgical specialties or practices using computers and/or mobile communication devices from diverse and different locations access said computer server or servers via the Internet can retrieve said interactive electronic templates to enter and submit said information and data 15 on or relating to diagnoses of diseases and disorders and related health, health-care and health-care services.

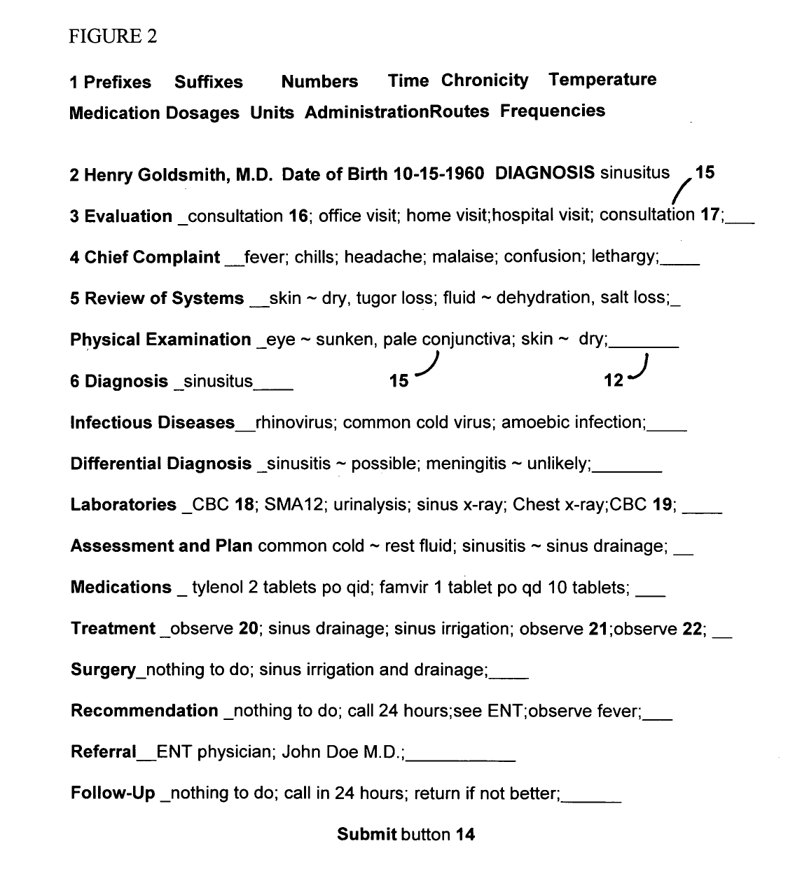

FIG. 2 illustrates an example of a preferred embodiment of the present invention wherein a first physician—a representative physician 2 Henry GoldSmith, M.D. in this Description being such as, but not limited to, a general internist, an infectious disease physician, a general practitioner or a neurologist—can use said primary and secondary interactive electronic templates to enter a DIAGNOSIS of sinusitus and related information and data 15 on sinusitus and related health, health-care and health-care services 15 as briefly shown in FIG. 2 wherein said 2 Tag Means represents by the identity of said physician and a related diagnosis relating to said information and data and wherein each “______” 12 in FIG. 1 represents an interactive box or space in said interactive electronic templates—now showing retrieved said information and data 15 on and related to health, health-care and health-care services—in FIG. 2.

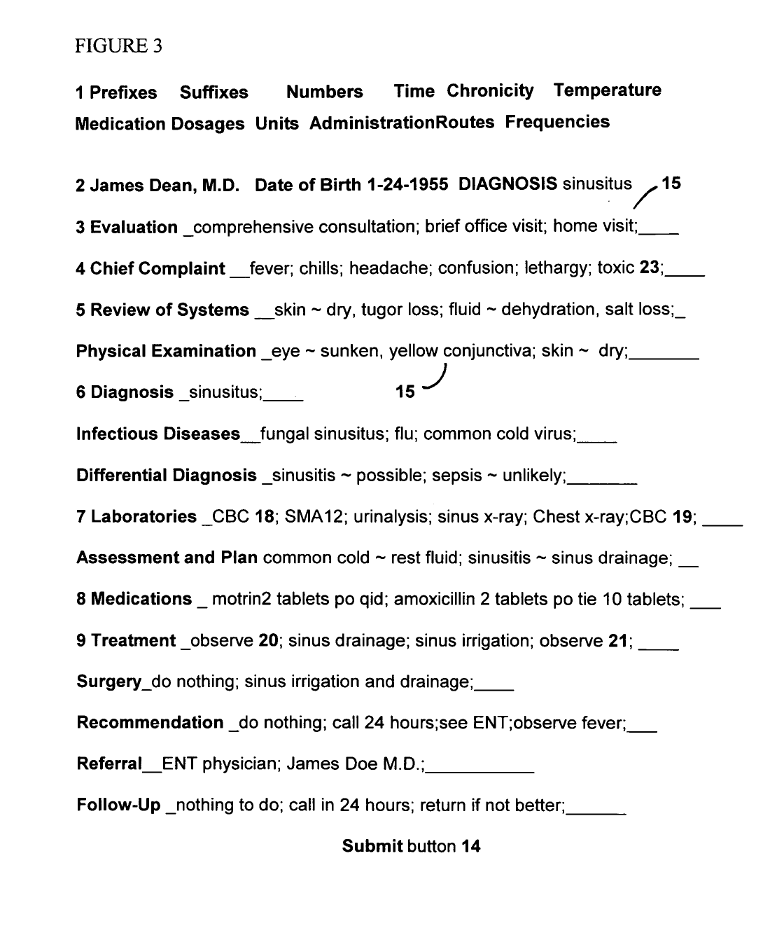

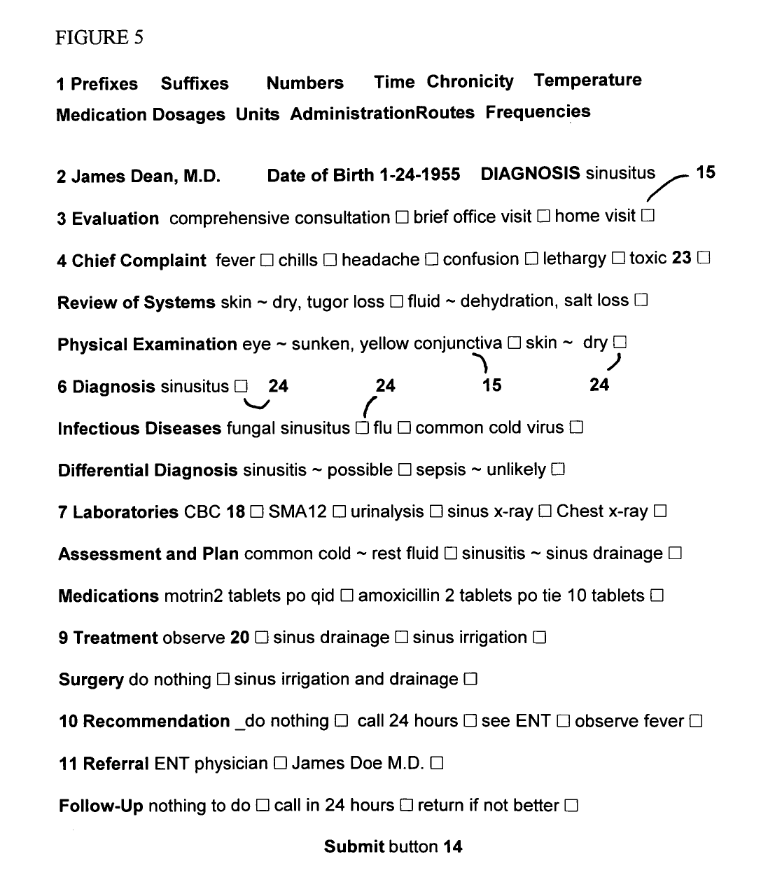

Yet another example, a second representative 2 James Dean, M.D., being such as, but not limited to, a general internist, an infectious disease physician, a general practitioner or a neurologist—among physicians—can use a primary interactive electronic template and a secondary interactive electronic template 13 schematically represent by FIG. 1 to enter said same representative DIAGNOSIS of sinusitus and related information and data on sinusitus and related health, health-care and health-care services as briefly shown in FIGS. 3 and 5 relating to 2 James Dean, M.D. wherein said 2 James Dean, M.D.'s information and data 15 are different—containing more or less or different words and terms—from those of said first representative Henry Goldsmith, M.D. in FIGS. 2, 4 and 6.

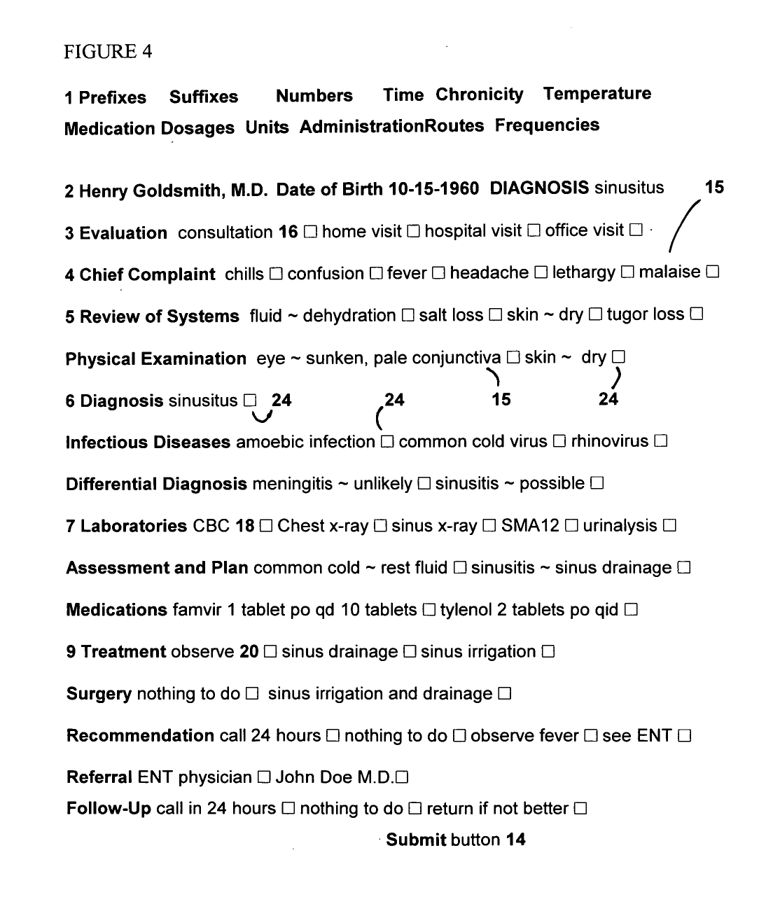

Using the Submit button 14 schematically representing the process of submitting said information and data 15 to said database or databases, said 2 physician can submit said information and data 15 described herein to said database or databases. Consequently, said submission can be repetitively retrieved from said database or databases and use by said physician generator as an electronic protocol viewable as schematic interactive electronic template as shown in FIG. 2 wherein each of the sample delimitors such as, but not limited to, “;” or “˜” is replaced by □24 in FIG. 4 representing one of the preferred embodiments of the interactive means for physicians such as, but not limited to, to check or uncheck said boxes for interact with or use said innovative computer program or software to repetitively manipulate, relate, modify and/or edit and/or enter and store information and data relating to diagnoses and related in said database or databases provide by said computer program and software. FIGS. 3 and 5 again explain said preferred embodiment comprising of slightly different information and data 15—more or less—relating to said diagnosis and use by yet another representative physician, 2 James Dean, M.D., using same said diagnosis and same said preferred embodiment.

FIG. 3 schematically represents a few preferred embodiments of the present invention relating to repetitively retrieving of said information and data onto a viewing screen of computer or mobile communication device wherein said information and data 15 in each and every heading—3 Evaluation, 4 Chief Complaint, 5 Review of Systems, Physical Examination, 6 Diagnosis, Infectious Diseases, Differential Diagnosis, 7 Laboratories such as, but not limited to, Imaging, Body Fluid Tests and Tissues Examination, Assessment and Plan, 8 Medications, 9 Treatment, Surgery, 10 Recommendation, 11 Referral and Follow-up—can be manipulated, modified, edited and/or improved such as, but not limited to, additions, deletions and changes of items of said information and data by a physician by said physician to suit said physician's uses. Said processes are enabled by said innovative computer program and software.

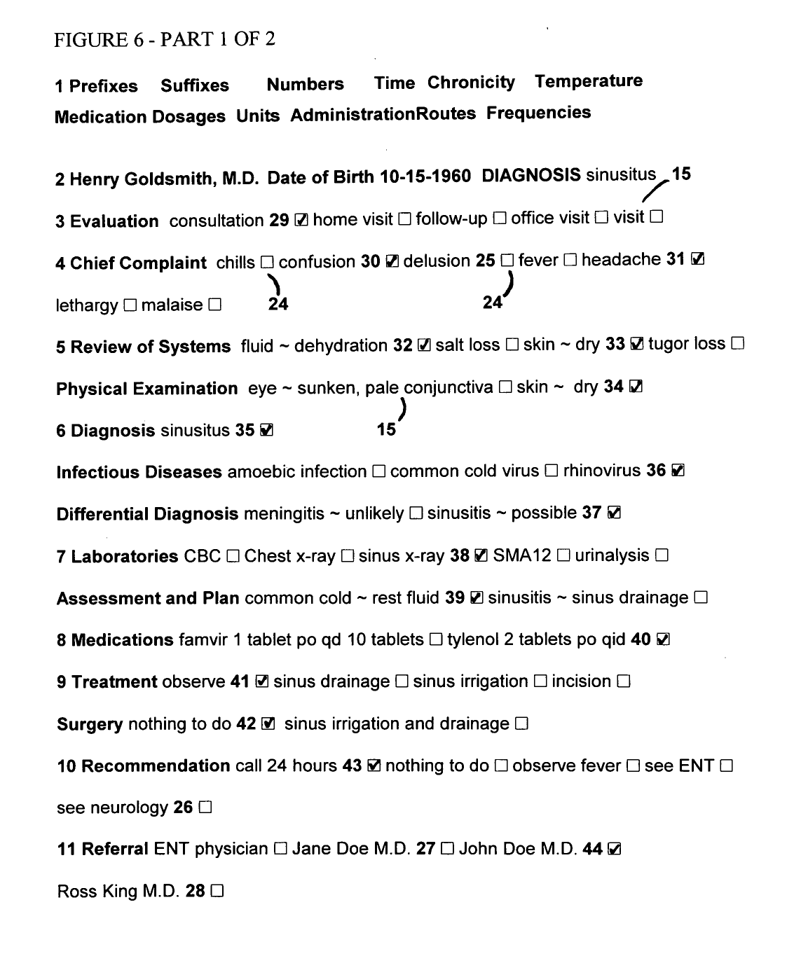

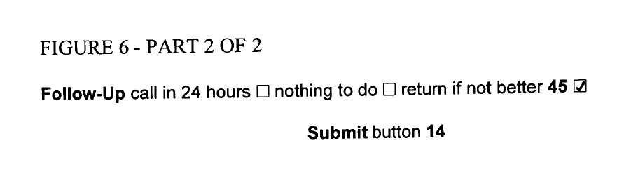

For example, FIGS. 2, 4, and 6—a rudimentary, representative composition of said information and data 15 being generated and enlarged by a representative physician representing a vast individual compositions of information and data and thousands of physicians—schematically represents one of said preferred embodiments of the present invention relating to said repetitively retrieving and manipulation, modified, edited and/or improved as the results of said representative physician Henry Goldsmith's manipulation, modification, edition and/or improvement of the contents in said interactive electronic templates schematically represent by FIGS. 2, 4 and 6. Said physician using template in FIG. 1 and as described supra, achieved information and data in FIG. 2 wherein said information and data are retrieved and displayed to said physician in interactive electronic templates schematically represent by FIGS. 2 and 4. However, using said preferred embodiments in FIG. 2 or 4, said physician can repetitively manipulate, modify, edit and/or improve such as, but not limited to, additions, deletions and changes of items of said information and data 15 by said physician to suit said physician's uses. For example, supra is achieved by said representative physician, Henry Goldsmith, M.D., wherein representative information and data represent by the following three terms “delusion” “see neurology”, “Jane Doe M.D.” and “Ross King M.D.” (not shown in FIG. 2) are entered into said database or databases using electronic interactive template schematic FIG. 2 in the headings of 4 Chief Complaint and 11 Referral and submitted by said physician into said database or databases. Upon the retrieval of said information and data, the result of said submission is schematically and briefly shown in FIG. 6—a representative composition of said information and data albeit simple and rudimentary—wherein delusion 24, see neurology 26, Jane Doe M .D. 27 and Ross King M.D. 28—which are not shown in FIG. 4 Chief Complaint and 11 Referral FIG. 6 are added to said information and data 15 related to 2 Henry Goldsmith, M.D. using said preferred embodiments in FIG. 2. The opposite, i.e. the repetitive modifications of said information and data such as, but not limited to, the deletions of component of said information and data 15 can be achieved using the preferred embodiments schematically represent by FIG. 4 which are provided as a means for modifying—adding or deleting—and submitting said information and data into said database or databases. In FIGS. 4 and 6 and subsequent figures, each said □24 represents one of the preferred embodiments of the interactive means for physicians such as, but not limited to, to check or uncheck said boxes for interact with or use said innovative computer program or software to repetitively manipulate, relate, modify and/or edit and/or enter and store information and data relating to diagnoses and related in said database or databases provide by said computer program and software.

Said FIGS. 1-6 and description represent examples of said information and data 15 being generated by physicians which are submitted into and processed, related, stored, compiled in said database or databases wherein said information and data schematically represent in FIGS. 1-6 are repetitively retrieved by relating physicians from said database or databases and said information and data and contents of said compositions are repetitively manipulated, modified, edited and/or improved and composed by relating physicians to suit and be used by said physician composers. In other words, said information and data 15 in said database or databases represent by those in said FIGS. 2-6 are repetitively manipulated, modified, edited and/or improved and composed by relating physicians to suit and be used by said relating physicians.

First, even furthermore, one of the preferred embodiments of generating and using the compositions of said information and data of the present invention by individual physician owners of said compositions, the present invention provides said computer program and software providing a means for checking for repeats, doubles or similars in individual submissions of said information and data on and/or relating to individual diagnoses by physicians. In other words, the present invention provides said computer program and software which scan and check for redundant repeats, doubles or similars in each and every said heading or headers in each and every submission of said information and data by every physician. For first example, FIG. 2 represents a simple and rudimentary example of this preferred embodiment wherein a representative physician, Henry Goldsmith, M.D., enters and submits repeated words, terms or phrases twice or more in a heading or headings—as in 3 Evaluation showing two repeats or doubles—consultation 16 and consultation 17, in 7 Laboratories showing two repeats or doubles—CBC 18 and CBC 19 and in 9 Treatment showing three repeats or doubles—observe 20, observe 21 and observe 22. Said innovative computer program and software scan, select and store only words and terms or phrases in a heading and headings without redundant repeat, double, extra or duplicate. In other words, therefore, relating to a diagnosis—Sinusitus and related information and data—said representative physician enters and submit 3 Evaluation showing two repeats or doubles—consultation 16 and consultation 17, in 7 Laboratories showing two repeats or doubles—CBC 18 and CBC 19 in 9 Treatment showing three repeats or doubles—observe 20, observe 21 and observe 22, said computer program and software scan, select and store only one consultation 16 or consultation 17 relating to 3 Evaluation, scan, select and store only one CBC 18 or CBC 19 relating to 7 Laboratories, and scan, select and store only one observe 20, observe 21 or observe 22 relating to 9 Treatment relating to said Sinusitus in said database or databases from which said one representative composition of said information and data is retrieved—and is manipulated, modified, edited and/or improved and further composed by said physician to suit and to be used by said physician composer as schematically represents by FIG. 4 wherein neither redundant repeat nor double is present. Said process can be repeated by said representative physician composer.

For second example, FIG. 3 represents a simple and rudimentary example of this preferred embodiment wherein another representative physician, James Dean, M.D., by coincidence, enters and submits almost same information and data 15 as those of said Henry Goldsmith, M.D. including repeated words, terms or phrases twice or more in a heading or headings—as in 7 Laboratories showing two repeats or doubles—CBC 18 and CBC 19 and in 9 Treatment showing three repeats—observe 20 and observe 21. Said innovative computer program and software scan, select and store only words and terms or phrases in a heading and headings without redundant repeat, double, extra or duplicate. In other words, therefore, relating to a diagnosis—Sinusitus and related information and data—said representative physician enters and submit 7 Laboratories showing two repeats or doubles—CBC 18 and CBC 19 and in 9 Treatment showing three repeats—observe 20 and observe 21, said computer program and software scan, select and store only one CBC 18 or CBC 19 relating to 7 Laboratories, and scan, select and store only one observe 20 or observe 21 relating to 9 Treatment relating to said Sinusitus in said database or databases from which said one representative composition of said information and data is retrieved—and is manipulated, modified, edited and/or improved and further composed by said physician to suit and to be used by said physician composer as schematically represents by FIG. 5 wherein neither redundant repeat nor double is present. Said process can be repeated by said representative physician composer.

Said innovative computer program and software repeat said processes for each and every heading and said setting for any and all submissions by physicians. The above processes and outcomes produce by said innovative computer software and program can be repetitively effected for said representative physicians—and for any and all physicians—in their repetitive advancements of the compositions of said information and data 15 on and relating to diagnoses and related diseases, disorders and said information and data to suit and be used by any and all physician composers.

In summary, therefore, FIGS. 1-6 schematically represent and describe one of the preferred embodiments of the present invention which provides individual physicians of about 85 medical and surgical specialties or practices with said innovative computer program and software for generating or producing individual compositions of information and data on or relating to individual DIAGNOSES on and relating to individual diseases and disorders and related health, health-care and health-care services produce and use by individual physicians to suit and be used by individual physicians. To be efficient, redundant words, terms and phrases generated by said physicians in each heading are scanned and selected so that said redundant words, terms and phrases or repeats, doubles or similars are removed from or not stored in said database or databases from which said compositions of said information and data are repetitively retrieved and manipulated, modified, edited and/or improved and further composed by physicians to suit and to be used by said individual physician composers to enhance or optimize the accuracy of the recording of said information and data, to assist with and/or facilitate the medical decision makings and reduce or eliminate errors in decision makings of physicians, to improve and increase the efficiency of the processes of generating and recording health and health-care information and data, to expedite the process or processes of entering and recording of said information and data into said database or databases by physicians and to reduce the repetitive efforts of physicians' productions of same or similar said information and data and relating errors.

### First Stage—II. Compositions of Physicians' Compiled Data

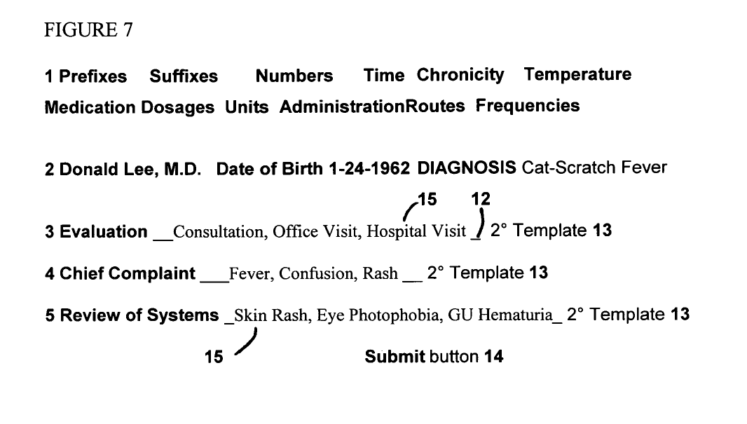

Further to supra, FIGS. 7-10 schematically represent and describe yet another preferred embodiment of the present invention which provides physicians of about 85 medical and surgical specialties or practices with said innovative computer program and software for generating or producing individual compositions of compiled or pooled information and data on and relating to individual DIAGNOSES on and relating to individual diseases and disorders and related health, health-care and health-care services produce or generate by different physicians on said individual diagnoses and related diseases and disorders and health, health-care and health-care services and wherein said innovative computer program and software make available said compositions—individual compilations of said information and data on individual diagnoses, diseases, disorders and said related—generated or produced by physicians—to physicians to be repetitively manipulated, modified, edited and/or improved, composed, enlarged and used by physicians.

In other words, for example, using one diagnosis—representing the preferred embodiments encompassing diagnoses and related diseases, disorders and health, health-care and health-care services—hundreds or thousands of physicians generate or produce information and data on and relating to said diagnosis and related diseases and disorders and related health, health-care and health-care services which are submitted into and processed, related, stored, compiled or pooled in said database or databases wherein said information and data are repetitively retrieved by physicians from said database or databases and wherein said information and data and contents of said compositions on said one diagnosis are repetitively manipulated, modified, edited and/or improved, composed and enlarged by physicians.

For example, the schematics in FIGS. 7, 8, 9 and 10 which are truncated by removing other headings present in said other Figures, although all said headings—3 Evaluation, 4 Chief Complaint, 5 Review of Systems, Physical Examination, 6 Diagnosis, Infectious Diseases, Differential Diagnosis, 7 Laboratories such as, but not limited to, Imaging, Body Fluid Tests and Tissues Examination, Assessment and Plan, 8 Medications, 9 Treatment, Surgery, 10 Recommendation, 11 Referral and Follow-up (and more headings as needed)—are provided to and used by physicians as shown in other Figures, and showing only three headings as representative of the illustration of said preferred embodiments.

First, in FIG. 7, on and relating to a representative diagnosis—Cat-Scratch Fever—from a list of hundreds of diagnoses, any physicians such as, but not limited to, a first representative physician whose name is 2 Donald Lee, M.D. and his date of birth—which also is represented as 2 Tag Means in FIG. 1—using said preferred embodiments of the present invention as represent by FIG. 1 into which 2 Donald Lee, M.D. enters information and data 15 into each “______” 12 in FIG. 1 representing an interactive box or space in said interactive electronic templates—now showing retrieved said information and data 15 on and related to health, health-care and health-care services in FIG. 7 in 3 Evaluation as Consultation, Office Visit, Hospital Visit 15, in 4 Chief Complaint as Fever, Confusion, Rash 15 and in 5 Review of Systems as Skin Rash, Eye Photophobia, GU Hematuria 15 by keyboarding and/or using related information and data from the drop-down list of information and data by clicking 2° (Secondary) Template 13 as schematically shown in FIG. 7 and taught supra in the schematics in FIGS. 1, 2 and 3. Said abbreviated and representative information and data 15 are submitted by 2 Donald Lee, M.D. wherein, as taught supra, said innovative computer program and software scan and check for repeats, doubles or similars—not present in 2 Donald Lee, M.D.'s this entry in FIG. 7, unlike those of other physicians supra—in said submission and wherein said information and data relate to said representative diagnosis—Cat-Scratch Fever—are entered and stored, compiled or pooled in said database or databases without repeats, doubles or similars in each and every heading in said database or databases.

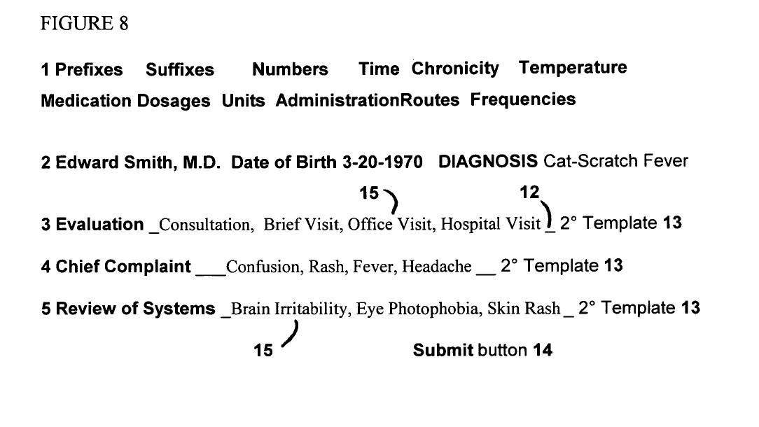

Second, in FIG. 8, on and relating to a representative diagnosis—Cat-Scratch Fever—from a list of hundreds of diagnoses, any physicians such as, but not limited to, a first representative physician whose name is 2 Edward Smith, M.D. and his date of birth—which also is represented as 2 Tag Means in FIG. 1—using said preferred embodiments of the present invention as represent by FIG. 1 into which 2 Edward Smith, M.D. enters information and data 15 into each “______” 12 in FIG. 1 representing an interactive box or space in said interactive electronic templates—now showing retrieved said information and data 15 on and related to health, health-care and health-care services in FIG. 8 in 3 Evaluation as Consultation, Brief Visit, Office Visit, Hospital Visit 15, in 4 Chief Complaint as Confusion, Rash, Fever, Headache 15 and in 5 Review of Systems as Brain Irritability, Eye Photophobia, Skin Rash 15 by keyboarding and/or using related information and data from the drop-down list of information and data by clicking 2° (Secondary) Template 13 as schematically shown in FIG. 8 and taught supra in the schematics in FIGS. 1, 2 and 3. Said abbreviated and representative information and data 15 are submitted by 2 Edward Smith, M.D. wherein, as taught supra, said innovative computer program and software scan and check for repeats, doubles or similars—not present in 2 Edward Smith, M.D.'s this entry in FIG. 8, unlike those of other physicians supra—in said submission and wherein said information and data relate to said representative diagnosis—Cat-Scratch Fever—are entered and stored, compiled or pooled in said database or databases without repeats, doubles or similars in each and every heading in said database or databases.

Said information and data 15 on Cat-Scratch Fever and related information and data of said representative 2 Edward Smith, M.D. are slightly different than those of said representative 2 Donald Lee, M.D. However, furthermore, said innovative computer program and software scan and compare said submitted information and data 15 on Cat-Scratch Fever and related information and data of 2 Edward Smith, M.D. and information and data 15 on Cat-Scratch Fever and related information and data present and store in said database or databases which at this rudimentary and representative state comprising on those submitted supra 2 Donald Lee, M.D. In other words, each heading to corresponding heading, before 2 Edward Smith, M.D.'s submitted information and data 15 are entered, related and stored in said database or databases, 3 Evaluation Consultation, Brief Visit, Office Visit, Hospital Visit 15 of 2 Edward Smith, M.D. is compared with stored and related Consultation, Office Visit, Hospital Visit 15 submitted supra by 2 Donald Lee, M.D. in said database or databases, 4 Chief Complaint Confusion, Rash, Fever, Headache 15 of 2 Edward Smith, M.D. is compared with stored and related Fever, Confusion, Rash 15 of 2 Donald Lee, M.D. in said database or databases, and 5 Review of Systems as Brain Irritability, Eye Photophobia, Skin Rash 15 of 2 Edward Smith, M.D. is compared with stored and related Skin Rash, Eye Photophobia, GU Hematuria 15 of 2 Donald Lee, M.D. in said database or databases.

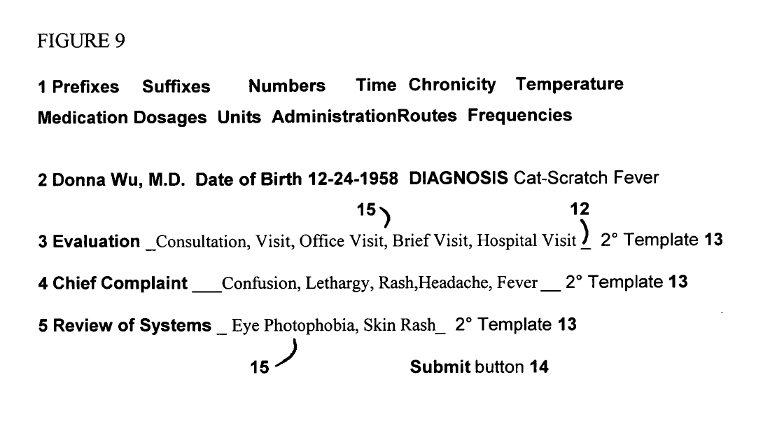

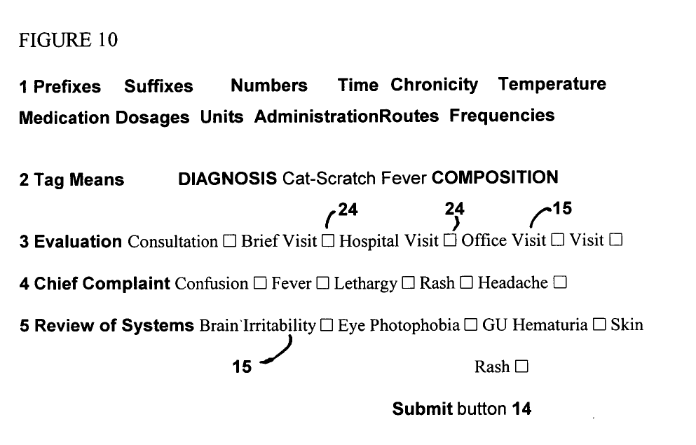

The result of said process is that said information and data in said database or databases, thus far based on said two representative submissions by two representative physician composers, have no repeat, double or similar for each and every heading in said database or databases and the result are schematically shown in FIG. 10—less the words and terms to be submitted by 2 Donna Wu, M.D. in FIG. 9 infra.

Third, further to supra, in FIG. 9, on and relating to a representative diagnosis—Cat-Scratch Fever—from a list of hundreds of diagnoses, any physicians such as, but not limited to, a first representative physician whose name is 2 Donna Wu, M.D. and his date of birth—which also is represented as 2 Tag Means in FIG. 1—using said preferred embodiments of the present invention as represent by FIG. 1 into which 2 Donna Wu, M.D. enters information and data 15 into each “______” 12 in FIG. 1 representing an interactive box or space in said interactive electronic templates—now showing retrieved said information and data 15 on and related to health, health-care and health-care services in FIG. 9 in 3 Evaluation as Consultation, Visit, Office Visit, Brief Visit, Hospital Visit 15, in 4 Chief Complaint as Confusion, Lethargy, Rash, Headache, Fever 15 and in 5 Review of Systems as Eye Photophobia, Skin Rash 15 by keyboarding and/or using related information and data from the drop-down list of information and data by clicking 2° (Secondary) Template 13 as schematically shown in FIG. 9 and taught supra in the schematics in FIGS. 1, 2 and 3. Said abbreviated and representative information and data 15 are submitted by 2 Donna Wu, M.D. wherein, as taught supra, said innovative computer program and software scan and check for repeats, doubles or similars—not present in 2 Donna Wu, M.D.'s this entry in FIG. 9, unlike those of other physicians supra—in said submission and wherein said information and data relate to said representative diagnosis—Cat-Scratch Fever—are entered and stored, compiled or pooled in said database or databases without repeats, doubles or similars in each and every heading in said database or databases. Said information and data of said third physician are slightly different than those of said first and second physicians' information and data on and relating to said diagnosis of Cat-Scratch Fever.

As described supra, said information and data 15 on Cat-Scratch Fever and related information and data of said representative 2 Donna Wu, M.D. are slightly different than compiled said information and data on and related to Cat-Scratch Fever in said database or databases generated supra by said representative 2 Donald Lee, M.D. and 2 Edward Smith, M.D. Therefore, said innovative computer program and software scan and compare said submitted information and data 15 on Cat-Scratch Fever and related information and data of 2 Donna Wu, M.D. and information and data 15 on Cat-Scratch Fever and related information and data present and store in said database or databases which—at this rudimentary and representative state—comprising those submitted supra by 2 Donald Lee, M.D. and 2 Edward Smith, M.D. In other words, each heading to corresponding heading, before 2 Donna Wu, M.D.'s submitted information and data 15 are entered, related and stored in said database or databases, 3 Evaluation Consultation, Visit, Office Visit, Brief Visit, Hospital Visit 15 of 2 Donna Wu, M.D. is compared with stored and related Consultation, Brief Visit, Office Visit, Hospital Visit 15 submitted supra by 2 Donald Lee, M.D. and 2 Edward Smith, M.D. which are present and related in said database or databases, 4 Chief Complaint as Confusion, Lethargy, Rash, Headache, Fever 15 of 2 Donna Wu, M.D. is compared with stored and related Confusion, Rash, Fever, Headache 15 submitted supra by 2 Donald Lee, M.D. and 2 Edward Smith, M.D. which are present and related in said database or databases, and 5 Review of Systems as Eye Photophobia, Skin Rash 15 of 2 Donna Wu, M.D. is compared with stored and related Brain Irritability, Eye Photophobia, Skin Rash, GU Hematuria 15 submitted supra by 2 Edward Smith, M.D. and 2 Donald Lee, M.D. which are in said database or databases.

The result of said process is that said information and data in said database or databases, thus far based on said three representative submissions by three representative physician composers, have no repeat, double or similar for each and every heading in said database or databases and the result are schematically shown in FIG. 10.

Further to said examples in FIGS. 7, 8, 9 and 10 based on said three representative physicians' entries which are submitted into said database or databases wherein said three representative physicians—as an example of one of the preferred embodiments of the present invention which is applicable to all physicians—generating almost same or different said information and data in same headings on a diagnosis—representing hundreds of diagnoses—and wherein said innovative computer program and software scan said submissions by said physicians and scan, check and select for all same headings for repeats, doubles or similars in said same headings so that said information and data are entered and stored, compiled or pooled in said database or databases without repeats, doubles or similars in said same headings.

Further to supra, said three representative physicians and other physicians can access said composition of said information and data on and related to said representative diagnosis—Cat-Scratch Fever—stored, compiled or pooled in said database or databases and the composition of said 3 physicians' information and data is schematically shown in FIG. 10 wherein each said □24 represents one of the preferred embodiments of the interactive means for physicians such as, but not limited to, to check or uncheck said boxes to repetitively manipulate, relate, modify and/or edit and/or enter and store information and data relating to diagnoses and related in said database or databases provide by said innovative computer program and software. By said process of compiling or pooling said three representative physicians' information and data on or relating to same in said database or databases without repeats, doubles or similars in said same headings, said composition can be repetitively retrieved and used by said three representative physicians and all physicians as schematically and succinctly represent in FIG. 10 of said preferred embodiment of the present invention wherein an interactive electronic template comprising said submitted information and data generated by said three representative physicians—or physicians as described herein—without repeat, double or similar in each heading as provided by said preferred embodiments of the present invention.

In other words, FIG. 10 schematically represents one of the preferred embodiments of the present invention using a representative diagnosis on Cat-Scratch Fever—from a list of hundreds of diagnoses—a comprehensive and organized composition of information and data on said diagnosis and related diseases, disorders and health, health-care and health-care services relating to said diagnosis are submitted, for example, by said 200,000 physicians who generate, contribute to and/or compose said information and data—represent by said 3 physicians supra—and said information and data are related, scanned, processed, compiled or pooled, and stored in said database or databases—by said innovative computer program and software—from which said information and data are repetitively retrieved, viewed, manipulated, related, modified and/or edited including items added or removed in said interactive electronic templates and successive generations of interactive electronic templates by said physicians wherein said information and data are repetitively related, scanned, processed, compiled or pooled and stored in said database or databases wherein said processes are repeated by said physicians and by said innovative computer program and software and wherein said manipulated, related, modified and/or edited are processed, related, compiled and stored in said database or databases by said innovative computer program and software.

Even furthermore, every physician can repetitively retrieve said compositions and manipulate, modify, edit and/or improve and compose said compiled or pool said information and data to suit and to be used by said every individual physician. In other words, said representative composition in FIG. 10 can be repetitively retrieved and manipulated, modified, edited and/or improved and composed by physicians to suit individual physician composers and be used by said physician composers. For example, said 200,000 American physicians—representation of physicians—using said schematic electronic interactive template in FIG. 10 use each said □24 representing one of the preferred embodiments of the interactive means for physicians such as, but not limited to, to check or uncheck said boxes to repetitively manipulate, relate, modify and/or edit and/or enter and store information and data relating to said diagnosis and related to generate information and data on or relating to said example diagnosis and related information and data and submit said information and data into said database or databases suit and be used by said every physician composer. Furthermore, said preferred embodiments apply to physicians wherein said information and data and compositions are repetitively retrieved and manipulated, modified, edited and/or improved and composed by physicians to suit said individual physician composers and/or said physicians. Moreover, said embodiments can be repetitively retrieved by all physicians—in any visually preferred presentations comprising any visually preferred orders of words and terms on the viewing screens of computer and mobile electronic devices—and used by physicians as schematically represented in FIGS. 1-10 supra.

Therefore, said preferred embodiments apply to physicians and diagnoses, diseases, disorders and related health, health-care and health-care services in about 85 medical and surgical specialties and practices and wherein said physicians repetitively retrieve, use and generate said information and data contributing to and enlarge said compiled or pool said information and data in said database or databases which are repetitively manipulated, related, modified and/or edited and used by said physicians and scanned, checked, manipulated, entered, stored, related and compiled in said database or databases and said adaptable compositions are repetitively produced and/or appropriately enlarged wherein said compositions are repetitively retrieved and presented to and used by said physicians by said innovative computer program and software.

Further to said preferred embodiments in FIRST STAGE—I. INDIVIDUAL PHYSICIANS' COMPOSITIONS OF DATA, another of the preferred embodiments of the present invention wherein said innovative computer program and software provides a means for checking for repeats, doubles or similars in individual submissions of said information and data on and/or relating to individual diagnoses and related information and data on health, health-care and health-care services by different physicians who generate and submit said information and data to said database or databases. In other words, on a diagnosis, said innovative computer program and software scan and check for repeats, doubles or similars in individual submissions on and/or relating to diagnosis generated and submitted by different physicians and said information and data generated and submitted by said physicians are entered and stored, compiled or pooled in said database or databases without repeats, doubles or similars in the headings and, consequently, said information and data are repetitively retrieved from said database or databases as compositions of information and data on and/or relating to said diagnosis, disease and/or disorder which are repetitively retrieved by physicians—who may or may be have generated, contributed to and/or composed said information and data—so that different physicians can repetitively share, retrieve and use said compiled or pool said information and data to benefit themselves to fulfill the goals and objections of the present invention.

For example, among all American physicians, if there are approximately 200,000 American internists, general practitioners, neurologists, physiatrists and infectious disease physicians, using a diagnosis Low Back Pain from list of hundreds of diagnoses used by and known to said physician and present in said physicians' specialties and practices, said many—200,000 physicians using said same example diagnosis generate individual submissions of information and data on and/or relating to said diagnosis and related information and data on health, health-care and health-care services as taught by said pending patent applications and supra. For Low Back Pain diagnosis, as an example, said physicians will generate same or different said information and data in same headings said physicians' generations of said information and data. Comparing same headings in said generations by said physicians, all same headings will have repeats, doubles or similars which are generated by said physicians, using FIG. 1, in their generations and submissions of said information and data to said database or databases. Said innovative computer program and software take said submissions by said physicians and scan and check and select for all same headings and scan, check for repeats, doubles or similars in said same headings so that said information and data are entered and stored, compiled or pooled in said database or databases without repeats, doubles or similars in said same headings. Said processes apply to all physicians and diagnoses. Furthermore, said processes can be repeated by said physicians wherein said information and data and compositions are repetitively retrieved and manipulated, modified, edited and/or improved and composed by physicians to suit said physician composers and/or said physicians.

In said three examples, said innovative computer program and software scan, process, select, relate and store said three submissions—and, applying said examples to said 200,000 physicians, much more than 200,000 submissions and subsequent retrievals, modifications and editions of said information and data—of said three physicians and said innovative computer program and software scan and modify and edit said information and data generated by physicians such as, but not limited to, inadvertent or unintentional typographical errors such as, but not limited to, unwanted “space”, punctuations and marks.

Yet first, according to the preferred embodiments of the present invention, said information and data schematically represent by those FIGS. 2, 3, 4, 7, 8 and 9 can be repetitively retrieved by physicians to be manipulated, modified, edited and/or improved and used by physicians and to be entered and submitted to said database or databases.

Yet second, according to the preferred embodiments of the present invention, said information and data schematically represent by those FIGS. 4, 5, 6, 10 can be repetitively retrieved by individual physician composers and other physicians to be manipulated, modified, edited and/or improved and used by physicians and to be entered and submitted to said database or databases.

Yet third, according to the preferred embodiments of the present invention, said information and data and compositions are schematically represent by those FIGS. 4, 5, 6, 10 can be repetitively retrieved by physicians to be manipulated, modified, edited and/or improved and used by physicians and to be entered and submitted to said database or databases and for individual physicians to adapt, manipulate, modify and edit including adding, deleting and rewriting words, terms and phrases of said compositions to suit and be used by individual physicians.

In addition, yet one of the preferred embodiments of the present invention, said innovative computer program and software provides said system and processes and physicians with yet another versatility of entering and submitting said diagnoses on diseases and disorders and related health, health-care and health-care services using Notepad or Wordpad commonly used by millions of computer users including computer programmers and physicians to present information and data in a .txt format and its derivatives and related to said computer program and software. And using said Notepad or Wordpad, said information and data and compositions are repetitively retrieved and manipulated, modified, edited and/or improved and composed by physicians to suit physicians and individual physician composers to fulfill the goals and objectives of the present invention.

Furthermore, the present invention also provides physicians with information and data on related diagnoses on diseases and disorders and related said relating information and data and information wherein said diagnoses on diseases and disorders and related said relating information and data and compositions are repetitively retrieved from said database or databases and viewed, manipulated, modified, edited and/or improved and used by physicians on interactive electronic templates on the viewing screens of said computers and portable communication devices.

Physicians such as, but not limited to, neurologists, infectious disease physicians, general practitioners and internists or any physicians of other medical or surgical specialties can retrieved said compiled or pooled information and data viewable and useable on said interactive electronic templates by entering or clicking from a drop-down list or menu of diagnoses to find the diagnosis Bacterial Meningitis—an example—and retrieve said compiled or pooled information and data. First, one of the preferred embodiments of the present invention, effect the use of said compiled or pooled information and data by said neurologists, infectious disease physicians, general practitioners and internists or said physicians. Second, one of the preferred embodiments of the present invention, effect the use of said compiled or pooled information and data by said any neurologists or said any physicians who contribute—modifications such as, but not limited to, the additions and/or deletions—additional information or data relating to Bacterial Meningitis to said compiled or pooled information and data on Bacterial Meningitis. Third, one of the preferred embodiments of the present invention, effect the manipulations, modifications and/or editions of said compiled or pooled information and data by said neurologists, infectious disease physicians, general practitioners, internists and said physicians and then submission of said manipulated, modified and/or edited compiled or pooled information and data which are repetitively retrieved by relating said individual neurologists or relating said individual physicians to repeat said processes and to achieve the goals and objectives of the present invention.

Further to said example, using a diagnosis Bacterial Meningitis as an example in one of the preferred embodiments of the present invention, enable by said innovative computer program and software, the present invention enables experts such as, but not limited to, neurologists, infectious disease physicians, general practitioners and internists to generate diagnoses on diseases and disorders and related said relating information and data and information on Bacterial Meningitis which are submitted by said physicians to and processed, related, compiled or pooled and stored in said database or databases. Furthermore, said innovative computer program and software can also link said diagnoses on diseases and disorders and related said relating information and data and information on Bacterial Meningitis and also other pertinent, related or relevant information and data on other medical and surgical topics such as, but not limited to, Bacteriology, Virology, Parasitology, Protozoans, Rickettsial and Fungal Infections, Fever, Headaches, epidemiology, tests and medications relating to Bacterial Meningitis.

### Second Stage—Physicians' Double Checks and Entries

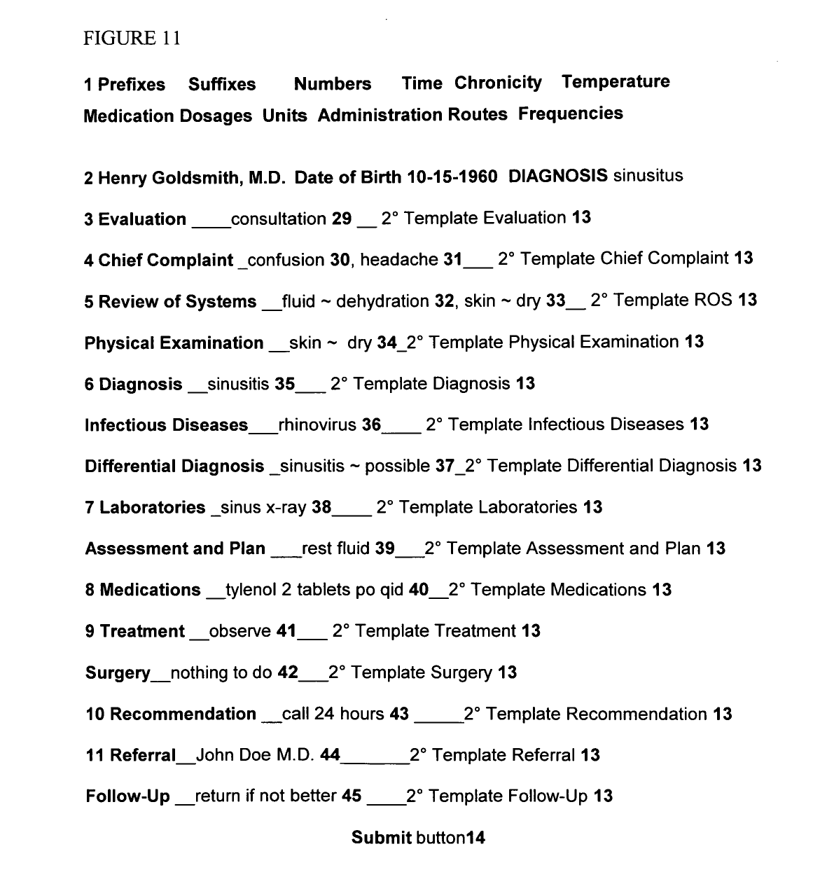

Further to supra, one of the preferred embodiments of the present invention—taught by said pending patent applications—are further detailed by the schematics in FIGS. 6 and 11 to illustrate said preferred embodiments of the present invention.

Said 1 Prefixes, Suffixes, Numbers, Time, Medication Dosages, Units, AdministrationRoutes and Frequencies represent tens to hundreds of interactive prefixes and suffixes—support by said innovative computer software and program and JAVA Script—such as, but not limited to, sidedness such as left, right, bilateral, contralateral, 1, 2, 3, 4, 5, 6, 7, 8, 9, 0, milligrams, c.c., oral, parenteral, bid, tid, qid and the like, etc. applicable to be related or entered with the contents entered to the right of said word and term headers and in this setting representing one of the preferred embodiment of the present invention each said □24 representing one of the preferred embodiments of the interactive means for physicians such as, but not limited to, to check or uncheck said boxes for interact with or use said innovative computer program or software to repetitively manipulate, relate, modify and/or edit and/or enter and store information and data relating to a representative diagnosis—Sinusitis—and related in said database or databases provide by said innovative computer program and software the related said information and data in the headings such as, but not limited to, 3 Evaluation, 4 Chief Complaint, 5 Review of Systems, Physical Examination, 6 Diagnosis, Infectious Diseases, Differential Diagnosis, 7 Laboratories such as, but not limited to, Imaging, Body Fluid Tests and Tissues Examination, Assessment and Plan, 8 Medications, 9 Treatment, Surgery, 10 Recommendation, 11 Referral, and Follow-up in FIG. 6—a representative composition of said information and data albeit simple and rudimentary—to be related and compiled in said database or databases. In this representative setting, for example, checks are placed into boxes □24 by said representative physician, Henry Goldsmith, M.D., for which information and data to the left of checked boxes □24 are represented in FIG. 6 by consultation 29□, confusion 30□, headache 31□, fluid˜dehydration 32□, skin—dry 33□, skin˜dry 34□, sinusitus 35□, rhinovirus 36□, sinusitis˜possible 37□, sinus x-ray 38□, common cold˜rest fluid 39□, tylenol 2 tablets po qid 40□, observe 41□, nothing to do 42□, call 24 hours 43□, John Doe M.D. 44□, return if not better 45□. Submit button 14 is then clicked upon completion of said processes of checking boxes □24 in the headings as shown in FIG. 6 by said Henry Goldsmith, M.D. and said selected information and data are submitted into said database or databases. Said submitted information and data—consultation 29, confusion 30, headache 31, fluid˜dehydration 32, skin˜dry 33, skin˜dry 34, sinusitus 35, rhinovirus 36, sinusitis˜possible 37, sinus x-ray 38, common cold˜rest fluid 39, tylenol 2 tablets po qid 40, observe 41, nothing to do 42, call 24 hours 43, John Doe M.D. 44, return if not better 45—are retrieved from said database or databases and appropriately present in the headings in the “______” 12 in FIG. 11 representing an interactive box or space in an interactive electronic template—now showing retrieved said information and data represent by FIG. 11 and wherein said representative physician can view and further manipulate, modify, edit and/or improve such as, but not limited to, additions or deletions of more information and data to said information and data using said hundreds of 1 interactive prefixes and suffixes and using related information and data from the drop-down list of information and data by clicking 2° (Secondary) Template 13 and by keyboarding. Upon the completion of said modification, edition and/or improvement, said information and data are submitted into said database or databases by clicking Submit button 14.

Said preferred embodiments of the present invention described using schematics in FIGS. 1-11 can be repetitively performed by physicians to repetitively generate, produce, manipulate, modify, edit and/or improve and use information and data by physicians and to enter and submit said information and data into said database or databases. Said preferred embodiments also effect the repetitive manipulations, relations, modifications and/or editions and uses by physicians and scan, check, manipulations, storage, relations and compilations said information and data which enlarge or expand in said database or databases and said adaptable compositions are repetitively produced wherein said compositions are repetitively retrieved and presented to and used by said physicians and effected by said innovative computer program and software.

### Third Stage—Patients' Charts by Patients and Physicians

Said preferred embodiments of the present invention are further implemented with the following yet other preferred embodiments of the present invention by providing a method and an electronic platform means for generating, storing, relating, manipulating, updating and expanding health, health-care and health-care service information and data on patients and physicians by said patients, physicians and pharmacists and database means for generating, storing, relating, manipulating, updating and expanding said information and data which are created, enabled, supported and maintained by an innovative computer software and program invented and created and are functioning by the present patent applicant.

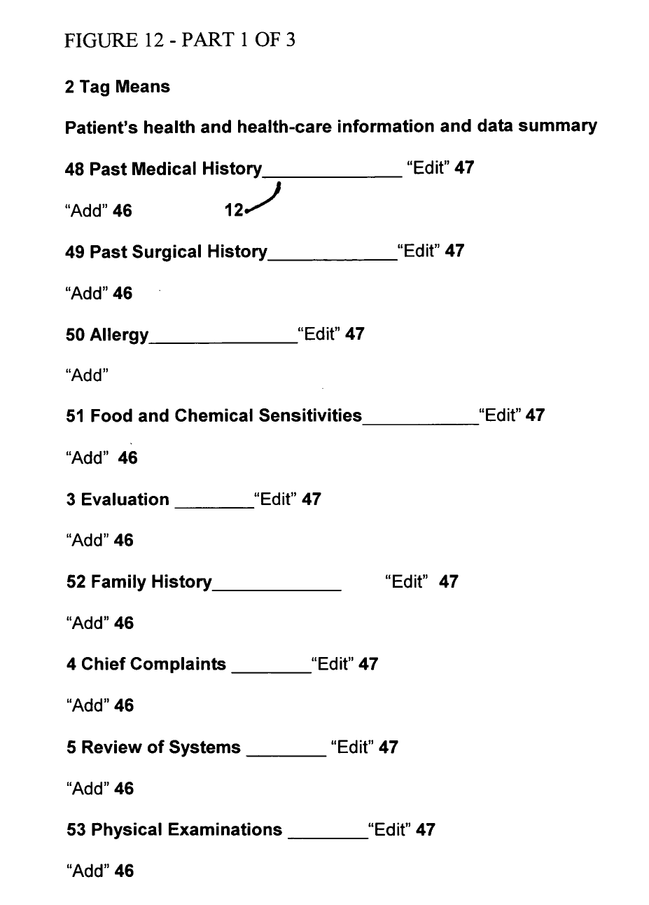

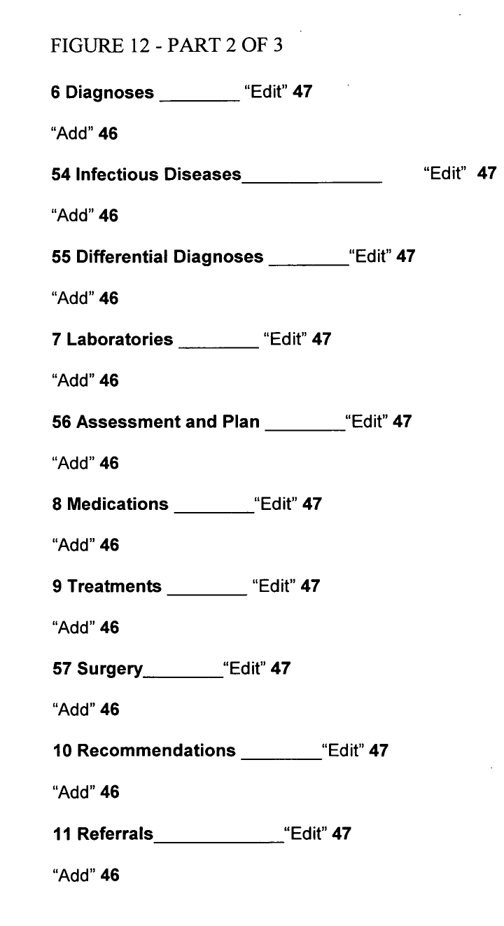

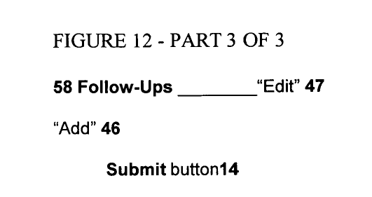

As taught in said pending patent applications, FIG. 12 schematically represents yet another electronic interactive template—an electronic health and health-care record of a patient—use by said patient and physicians having accesses to said patient's record.

In FIG. 12, 2 Tag Means tags or identifies said information and data such as, but not limited to, said patient's identity. “Add” 46 and “Edit” 47 use by said patient and physicians comprise interactive pop-up and/or drop-down lists and/or menus of words, terms, phrases, sentences, texts, synonyms, acronyms, texts, numbers, graphics, and word and term headers or headings comprising information and data on and relating to DIAGNOSES on diseases, disorders, health, health-care and health-care services use by physicians of about 85 medical and surgical specialties and practices. Moreover, interactive graphics such as, but not limited to, U.S. Pat. No. 6,132,218 which can be clicked to present pop-up and/or drop-down lists and/or menus of words, terms, phrases, sentences, texts, synonyms, acronyms, texts, numbers, graphics, and word and term headers or headings comprising information and data on and relating to diagnoses on diseases, disorders, health, health-care and health-care services use by physicians of about 85 medical and surgical specialties and practices viewable and useable by said physicians.

Furthermore, click buttons such as, but not limited to, the “Add” 46 , “Edit” 47, “View”(not shown) and “Submit” 14 buttons and the like to access linked interactive electronic templates to generate, relate, manipulate, update and expand said patient's health, health-care and health-care service information and data and to submit said information and data to said database or database by said physicians and patients resulting in perpetual said expansions, updates and improvements of said third primary templates viewable by said physicians and patients.

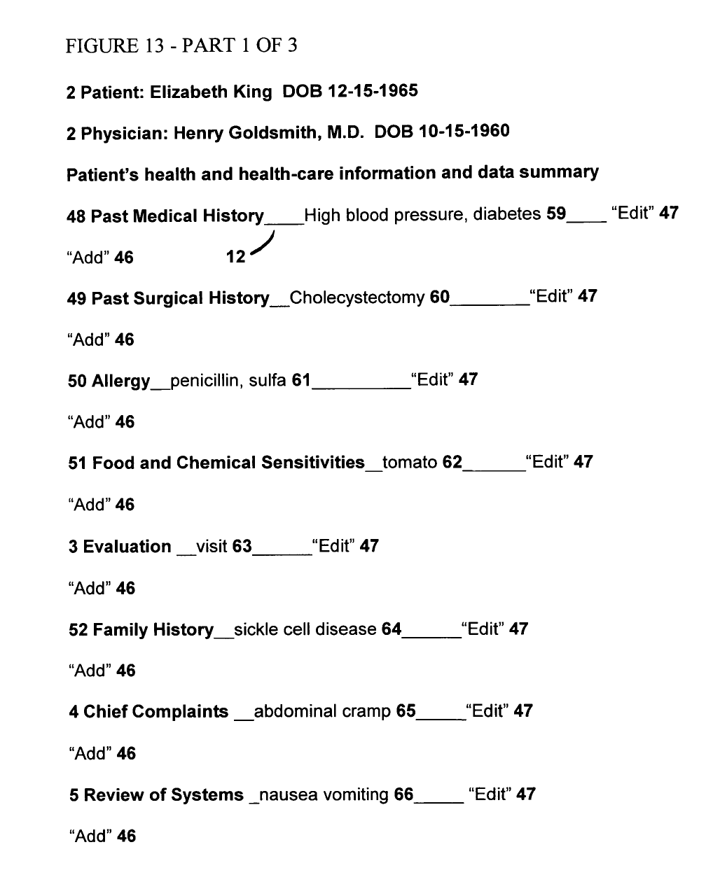

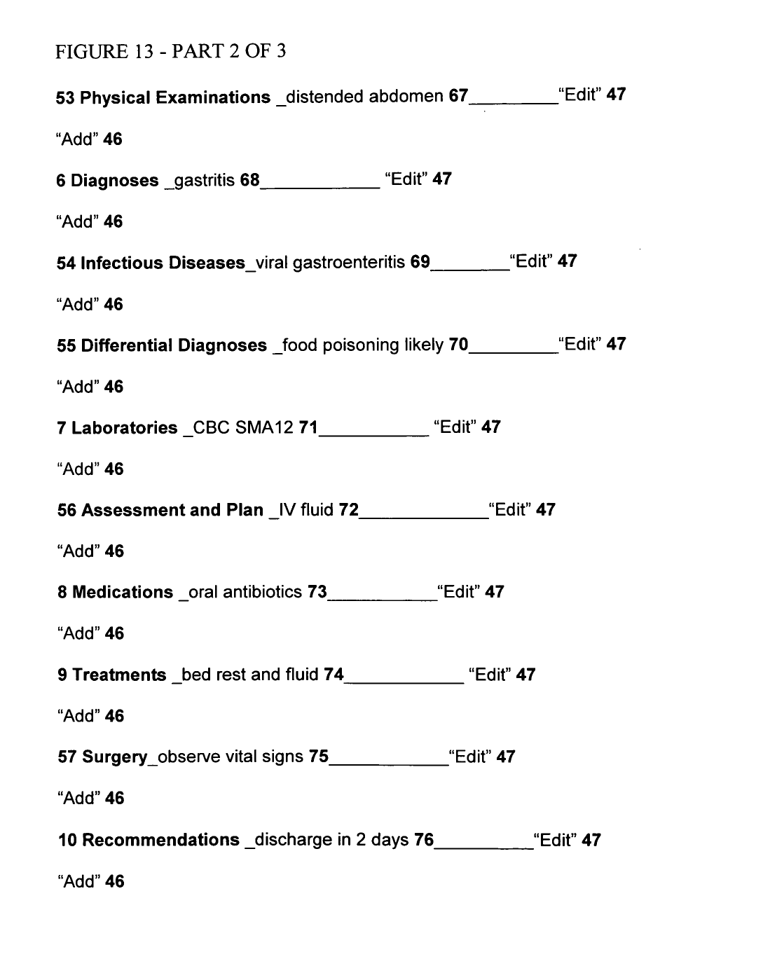

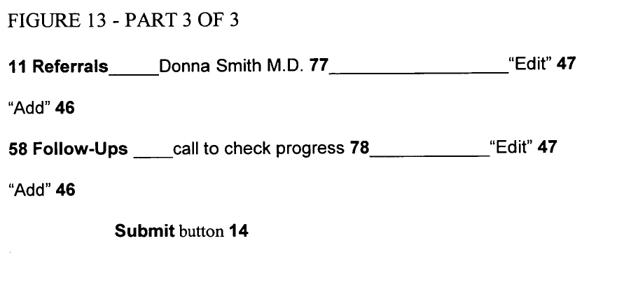

As taught by said pending patent applications, the schematics representing interactive electronic templates in FIG. 12 and FIG. 13 use by individual patient owners and physicians accessing said patient owners' record wherein each said patient owner and, subsequently, physicians have entered earlier the diagnoses, diseases, disorders, illnesses and related information and data on health, health-care and health-care services and related and pertinent information and data which are schematically represented in FIG. 13. As described in Figures supra, the 2 Tag Means in FIG. 12 represents by the identity of patient owner of information and data and individual identities of individual physicians having accesses to said patient owner's record in FIG. 13. In FIG. 12 and FIG. 13, headings such as, but not limited, 48 Past Medical History, 49 Past Surgical History, 50 Allergy, 51 Food and Chemical Sensitivities, 3 Evaluation, 52 Family History, 4 Chief Complaint, 5 Review of Systems, 53 Physical Examination, 6 Diagnosis, 54 Infectious Diseases, 55 Differential Diagnosis, 7 Laboratories such as, but not limited to, Imaging, Body Fluid Tests and Tissues Examination, 56 Assessment and Plan, 8 Medications, 9 Treatment, 57 Surgery, 10 Recommendation, 11 Referral and 58 Follow-up (and more headings as needed) are provided by the preferred embodiments of the present invention as shown supra. Each “______” 12 following each said heading in schematics in FIG. 12 and FIG. 13 represents an interactive box or space in said interactive electronic templates wherein said information and data can be entered by said patient owner and physicians pursuant to the teaching supra.

For example, using FIG. 12, a representative patient Elizabeth King whose date of birth is 12-15-1965 enters her information and data on her health and health-care history in appropriate said headings—High Blood Pressure, diabetes 59, Cholecystectomy 60, penicillin, sulfa 61, tomato 62, visit 63, sickle cell disease 64, abdominal cramp 65, nausea vomiting 66, distended abdomen 67, gastritis 68, viral gastroenteritis 69, food poisoning likely 70, CBC SMA12 71, IV fluid 72, oral antibiotics 73, bed rest and fluid 74, observe vital signs 75, discharge in 2 days 76, Donna Smith M.D. 77 and call to check progress 78 as represent in FIG. 13 which also is accessed by said representative patient, Elizabeth King, who submit said related information and data to said database or databases and who can repetitively retrieve information and data and repetitively manipulate, modify, edit and/or improve her information and data by using click buttons such as, but not limited to, the “Add” 46, “Edit” 47, “View”(not shown) and “Submit” 14 buttons and the like by accessing linked interactive electronic templates to generate, relate, manipulate, update and expand said patient's health, health-care and health-care service information and data and to submit said information and data to said database or databases resulting in perpetual expansions, updates and improvements of said information and data of said representative patient viewable by said representative patient and physicians accessing her record—to said database or databases.

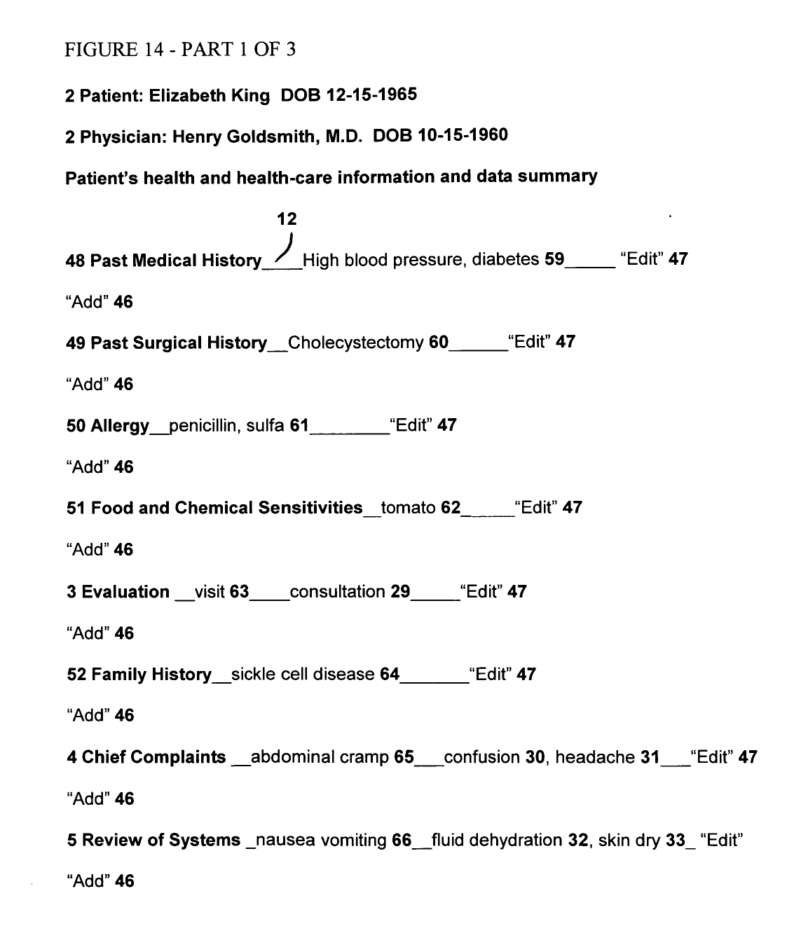

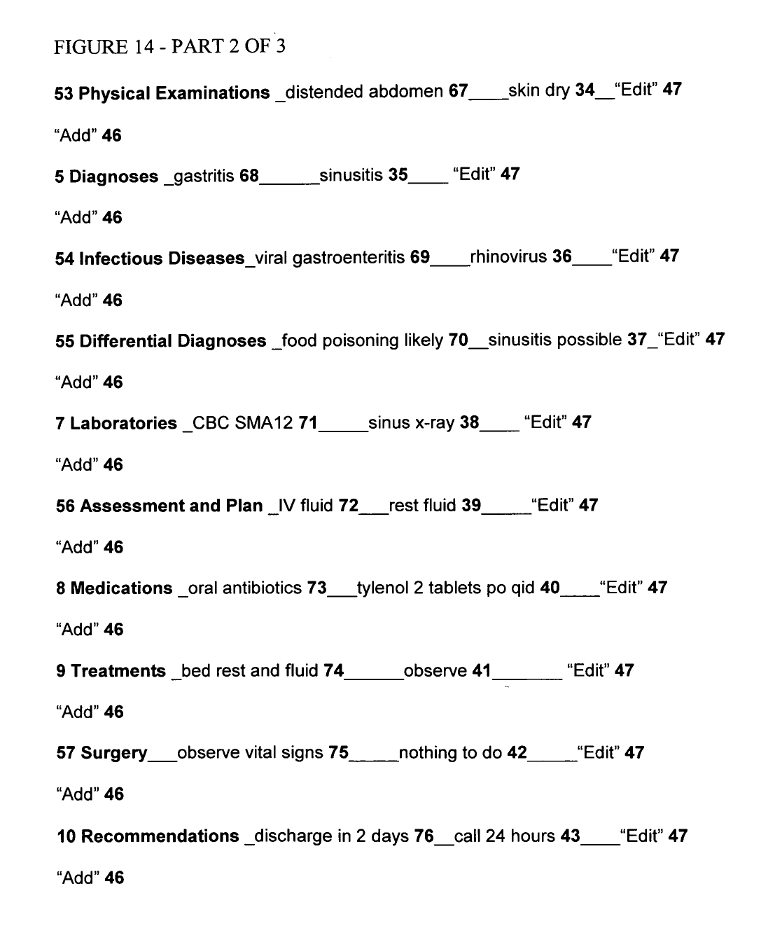

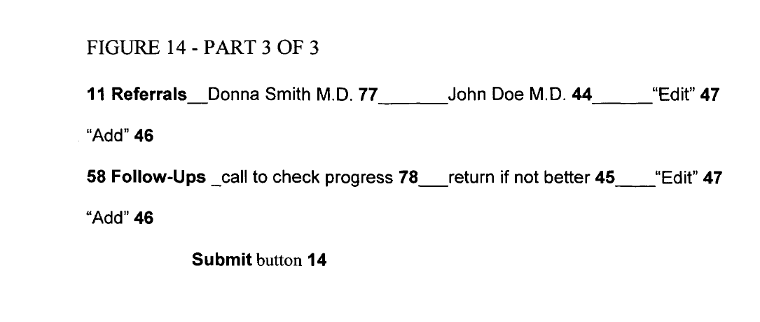

Using his access to Elizabeth King's said information and data, as taught in said pending patent applications, a representative physician—2 Henry Goldsmith, M.D.—retrieves and views Elizabeth King's record as shown in schematics of FIGS. 13 and 14.

Although not shown in FIG. 13 albeit yet another preferred embodiment of the present invention taught by said pending patent applications, said representative physician, Henry Goldsmith, M.D., can just as well—or even better than said representative patient owner, Elizabeth King—to repetitively manipulate, modify, edit and/or improve his patient's information and data by using click buttons such as, but not limited to, the “Add” 46, “Edit” 47 and “View” (not shown) and the like to access linked interactive electronic templates to generate, relate, manipulate, update and expand said patient's health, health-care and health-care service information and data and to submit said information and data using “Submit” 14 button to said database or databases to effect perpetual said expansions, updates and improvements of said representative patient viewable by said representative patient and physicians accessing said representative patient's record.

Further to supra then, schematics in FIGS. 11, 12, 13 and 14 represent one of the preferred embodiments of the present invention which enables physicians represent by said representative physician, Henry Goldsmith, M.D., to submit said representative information and data—consultation 29, confusion 30, headache 31, fluid˜dehydration 32, skin˜dry 33, skin˜dry 34, sinusitus 35, rhinovirus 36, sinusitis˜possible 37, sinus x-ray 38, common cold˜rest fluid 39, tylenol 2 tablets po qid 40, observe 41, nothing to do 42, call 24 hours 43, John Doe M.D. 44, return if not better 45—on Elizabeth King schematically present in FIG. 11 into said database or databases from which said information and data are retrieved and viewed in appropriate headings as shown in schematics in FIG. 14. Using schematics in FIGS. 11, 12, 13 and 14, said representative patient and physicians can generate, manipulate, modify, edit and/or improve including additions said information and data and repetitively retrieve said information and data and repetitively manipulate, modify, edit and/or improve information and data by using click buttons such as, but not limited to, the “Add” 46 , “Edit” 47, “View” (not shown) and “Submit” 14 buttons and the like by accessing linked interactive electronic templates to generate, relate, manipulate, update and expand said patient's health, health-care and health-care service information and data and to submit said information and data to said database or databases resulting in perpetual expansions, updates and improvements of said information and data of said representative patient viewable by said representative patient and physicians accessing her record—to said database or databases.

Said preferred embodiments apply to patients and physicians.

As taught by the present patent applicant's pending application Ser. No. 11/074,236 filed Mar. 7, 3005 entitled A System of Management of Health-care Resources, said innovative computer program and software also provides a means for blocking or excluding a physician or physicians, at any or all time, from accessing said digital information and data is permitted to a patient or a physician by the present invention. The process of the means involves the deleting—temporary (unlinking data on a patient and a physician or physicians of issue and the like) or permanently—a database of a physician or the databases of physicians by a patient. Therefore, a patient can deny authorization to access his or her information and data. Said embodiments apply to patients and physicians using the present invention.

The present invention, therefore, provides the system and method for enhancing or optimizing the accuracy of the recording of said information and data, assisting with and/or facilitate the medical decision makings and reducing or eliminating errors in decision makings of physicians, improving and increasing the efficiency of the processes of generating and recording health and health-care information and data, expediting the processes of entering and recording said diagnoses, diseases, disorders, illnesses and relating information and data on health, health-care and health-care services into said database or databases of said computer server or servers and to reducing the repetitive efforts of physicians' productions of same or similar said information and data and relating errors.

The above preferred embodiments apply to physicians of about 85 medical and surgical specialties and practices and to information and data on and relating to any and all diagnoses, diseases, disorders, health, health-care and health-care services. Therefore, physicians of about 85 medical and surgical specialties or practices using computers and/or mobile communication devices from diverse and different locations access said computer server or servers via the Internet can achieve said processes and outcomes as schematically represent in FIG. 1-14 supra for information and data on or relating to hundreds or thousands of diagnoses of diseases and disorders and related health, health-care and health-care services achieve and perform in about 85 medical and surgical specialties or practices.

In addition, based said preferred embodiments, the present invention also provides numerous interactive electronic templates comprising words, terms, phrases, sentences, word and term headers, texts and graphics comprising text-based interfaces and graphical user interfaces link and/or relate to interactive electronic templates and show information and data including details relate to said information and data in said interactive electronic templates wherein said interactive electronic templates are used by physicians and patients to manipulate, update and improve said information and data and compositions.

Furthermore, click buttons such as, but not limited to, the “Add”, “Edit”, “View” and “Submit” buttons and the like to access linked interactive electronic templates to generate, relate, manipulate, update and expand said patient's health, health-care and health-care service information and data and to submit said information and data to said database means by said physicians and patients resulting in perpetual said expansions, updates and improvements of said third primary templates viewable by said physicians and patients.

Even furthermore, as taught by pending patent application Ser. No. 12/321,141 entitled the Best system of health and health-care data management filed Jan. 16, 2009, one of the preferred embodiments of the present invention provides by said innovative computer program and software creates and effects the management of tests and laboratories such as, but not limited to, MRI, CTScan, blood tests wherein the entire process such as, but not limited to, an interactive scheduling between testing and laboratory physicians such as, but not limited to, radiologists, pathologists, testing laboratories, neurologists, gastroenterologists, physiatrists and the patients so that all orders of tests by physicians, the scheduling of tests between patients and test and/or laboratory physicians and their clinics or laboratories, the results of tests and the posting of the results of tests are achieved and/or produced using templates described herein and wherein said templates viewable by said patients and physicians or the technicians also show health information and data on patients such as, but not limited to, allergies, drug and food sensitivities and surgical implanted devices in said patients, past medical history, past surgical history, chief complaint or chief complaints and durations or durations, diagnoses, differential diagnoses. Said functions, processes, products and results can be implemented and used from any and several said primary and/or secondary templates. For example, in the current implementation, said functions, processes, products and results are accessed and used by said patients and physicians from said third templates and/or related secondary templates, by said physicians from the second templates and related secondary templates.

Similarly, furthermore, said computer software and program also create and effect the management of prescriptions and dispensations of medications wherein the entire process of prescriptions of the medications to the documentations of prescriptions by the pharmacists—prescriptions are prescribed by physicians, ordered by patients or physicians, patients or physicians directing prescriptions to pharmacists, notifications and records of the dispensations of medications by pharmacists to patients and physicians including times and dates of dispensations—are produced and documented in and supported by the templates described herein wherein said templates viewable by said patients, physicians and pharmacists also show health information and data on patients such as, but not limited to, allergies, drug and food sensitivities, past medical history, past surgical history, diagnoses, and medications which patients have taken and are taking. Said functions, processes, products and results can be implemented and used from any and several said primary and/or secondary templates. For example, in the current implementation, said functions, processes, products and results are accessed and used by said patients and physicians from said third templates and/or related secondary templates, by said physicians from the second templates and related secondary templates, and the pharmacists and/or their assistants can accessed and used said functions, processes, products and results and related from their electronic pages and/or templates created, maintain and operate by said computer software and program.

Moreover, as taught by pending patent application Ser. No. 12/321,141 entitled the Best system of health and health-care data management filed Jan. 16, 2009, one of the preferred embodiments of the present invention provides by said innovative computer program and software in said settings and circumstances using said features in said templates, prescribing physicians, laboratory physicians such as, but not limited to radiologists and pathologists, pharmacists and patients can send back and forth between said parties queries, choices and options and responses with regards to appointments and schedules and prescribing, ordering, fulfilling of prescriptions and records of dispensations of medications as the cases may be.

Further to supra, laboratory physicians such as, but not limited to radiologists and pathologists, pharmacists can upload from computers and mobile communication devices in their locations and setting the results of tests and laboratories and related—in various computer format such as, but not limited to, pdf, etc. and submit said results relating to patients and physicians to said database or databases of said server or servers in said network or networks.

It is to be understood that said preferred embodiments and examples apply to physicians and information and data on diseases and disorders in about 85 medical and surgical specialties or practices.

It is to be understood that the present invention comprising method, processes, system, protocols, matters, products, functions and related and derivatives—implemented, effect and operate by said innovative computer software and program operating in said computer server or servers—are far more complex, extensive, intelligent, versatile and more than two dimensional and more versatilely, logically and relationally organized, arranged and presented than said brief and simple representations herein.

Although it has been described in pending earlier patent applications, said data and information are words, terms, word and term headers and topics and subjects as shown above such as, but not limited to, Evaluation, Chief Complaints, Review of Systems, Diagnoses, Differential Diagnoses, Physical Examinations, Medications, Treatments, Surgeries, etc., phrases, synonyms, codes, numbers, sentences, texts and graphic, etc. used and use by physicians in all—approximately 85—medical and surgical specialties and practices to describe and document data and information on diseases, illnesses, disorders, health and health-care of patients and health-care services. At least Java Script and AJAX are used to support said templates, lists and menus.

The method, processes, system, protocols, matters, products, functions and related and derivatives of the present invention are implemented and effected by an innovative computer software and program invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server, SQL such as, but not limited to Microsoft SQL Server, MySQL and the like, Internet Explorer, Web browsers, Web server, Apache, Microsoft IIS, Visual Studio and Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations, requirements and equipment, server blades and various hardware and equipment configurations, virtual servers such as those sold by VMware, HP and IBM, and their derivatives being used by many large American corporations can and will be used to implement the present invention.

Consequent to the incorporations of said data and information using computer programs, software mentioned herein and the like, the products of said incorporations are stored in and retrieved from database or databases to be displayed on the viewing screens and comprehensible and use by patients and physicians.

It is understood that—by laws and ethics applicable to the present invention and said descriptions of the preferred embodiments—health, health-care and health-care service data and information on individual patients belongs or relates to said individual patients and are generated and safeguarded by physicians who are authorized by same to safeguard and to access and view said data and information.

Although various preferred embodiments of the present invention have been described, it will be appreciated by those skilled in the art that their adaptations, variations and derivatives may be made and achieved without departing from the spirit and the scope of the claims of the present invention.

1. A system of compositions of information and data on diagnoses of diseases and disorders and health, health-care and health-care services on and relating to said diagnoses of diseases and disorders for physicians for concordant management of information and data on health, health-care and health-care services wherein the contents of said compositions are derived from information and data on diagnoses, diseases, disorders, health, health-care and health-care services generated by physicians wherein said information and data are submitted, processed, related, stored, pooled and compiled in the database or databases of the computer server, computer servers, computer or computers—in a network or networks of computer servers, computers and portable communication devices—operating an innovative computer program and software invented and created by the present patent applicant and wherein said contents of said compositions are repetitively composed and/or compiled from said submitted, processed, related and compiled information and data in said database or databases by said innovative computer program and software wherein said compositions are repetitively retrieved from said database or databases and the information and data and contents of said compositions are repetitively manipulated, modified, edited and/or improved by physicians to suit and be used by said physician composers and submitted, processed, related, stored, compiled in said database or databases, wherein redundant repeats, doubles and/or duplicates or redundances of information and data occurring in every submission by every physician and redundant repeats, doubles and duplicates or redundances of information and data occurring in submissions on or relating to same diagnosis, disease or disorder by physicians are scanned and processed by said innovative computer program and software to result in the submissions of said information and data and compositions on or relating to same diagnosis, disease or disorder having no redundant repeat, double and duplicate into and/or in said database or databases wherein said results are related, pooled and/or compiled, wherein retrieved said compositions comprise no redundant repeat, double and duplicate are repetitively viewed, manipulated, modified, edited and/or improved and used by physicians, wherein said information and data and compositions are repetitively retrieved from said database or databases and viewed, manipulated, modified, edited and/or improved and used by physicians on interactive electronic templates on the viewing screens of said computers and portable communication devices, wherein said repetitive processes by physicians, said outcomes and said compositions are effected and enabled by said innovative computer program and software, and wherein queries, choices and options and responses with regards to appointments and schedules and prescribing, ordering, fulfilling of prescriptions and records of dispensations of prescriptions and medications are sent back and forth between physicians and pharmacists and staff people to enhance or optimize the accuracy of the recording of said information and data, to assist with and/or facilitate the medical decision makings and reduce or eliminate errors in decision makings of physicians, to improve and increase the efficiency of the processes of generating and recording health and health-care information and data, to expedite the process or processes of entering and recording of said information and data into said database or databases by physicians and to reduce the repetitive efforts of physicians' productions of same or similar said information and data and relating errors comprises:
information and data on diagnoses, diseases, disorders, health, health-care and health-care services generated by physicians;
compositions of information and data on diagnoses of diseases and disorders and health, health-care and health-care services on and relating to said diagnoses of diseases and disorders to suit and be used by physician composers of said compositions;
computer program means for generating, relating, processing, compiling and storing information and data on diagnoses, diseases, disorders, health, health-care and health-care services generated by physicians;
computer program means for composing said contents information and data on health, health-care and health-care services based on same diagnosis of diseases and disorders;
computer program means for composing said contents information and data on health, health-care and health-care services based on individual diagnoses of diseases and disorders;
computer program means for generating said contents of said compositions from related and compiled information and data on diagnoses, diseases, disorders, health, health-care and health-care services in said database or databases;
computer program mean for repetitively retrieving and showing said compositions on viewing screens of said computers and mobile communication devices to physicians;
computer program means for repetitively retrieving said processed, related and compiled information and data and said compositions which are repetitively viewed, manipulated, related, modified and/or edited by physicians
computer program means for processing, relating, compiling and storing said information and data and said compositions in said database or databases,
individual compositions of information and data on health, health-care and health-care services based on the diagnoses of diseases and disorders in said database or databases which are repetitively retrieved and used by physicians for concordant management of information and data on health, health-care and health-care services;
computer program mean for generating interactive electronic templates for repetitively retrieving said information and data and for enabling the manipulations, relating, modifications and editions of said information and data and composition by physicians;
computer program means for scanning and processing redundant repeats, doubles, duplicates and/or extras in information and data in every submission of said information and data by every physician;
computer program means for scanning and processing redundant repeats, doubles, duplicates and/or extras in information and data in submissions of said information and data on or relating to same diagnosis, disease or disorder by physicians;
computer program means for storing said compositions in said database or databases; and
computer program mean for generating interactive electronic templates wherein said information and data and compositions are repetitively retrieved from said database or databases of said computer server or serves by and displayed on said viewing screens of said computers and mobile communication devices to physicians; and
computer program mean for generating interactive electronic templates wherein said information and data and compositions are repetitively retrieved from said database or databases of said computer server or serves by and manipulated, modified, edited and/or improved by physicians using said computers and mobile communication devices; and
computer program means for repetitively processing, relating, compiling and storing said information and data and compositions in said database or databases;
computer program means for relating and compiling related and compiled information and data on relating diagnoses, diseases, disorders, health, health-care and health-care services in said database or databases;
computer program means for retrieving related and compiled information and data on relating diagnoses, diseases, disorders, health, health-care and health-care services in said database or databases for viewing and using by physicians;
computer program means for sending queries, choices and options and responses with regards to appointments and schedules and prescribing, ordering, fulfilling of prescriptions and records of dispensations of prescriptions and medications back and forth between physicians and pharmacists and staff people; and
computer program means for effecting said processes.

2. A method of composing information and data on health, health-care and health-care services relating to diagnoses of diseases and disorders for managing information and data on health, health-care and health-care services by physicians using computers and/or portable communication devices in a network or networks of computer servers, computers and portable communication devices wherein the contents of said compositions comprising diagnoses of diseases and disorders and said information and data are derived from information and data on or relating to diagnoses, diseases, disorders, health, health-care and health-care services generated by physicians wherein said information and data are submitted, processed, related, stored and compiled in the database or databases of the computer server, computer servers, computer or computers in said network or networks wherein said contents of said compositions are repetitively composed and/or compiled from said submitted, processed, related and compiled information and data in said database or databases wherein said compositions are repetitively retrieved from said database or databases and the information and data and contents of said compositions are repetitively manipulated, modified, edited and/or improved by physicians and are submitted into and processed, related, stored, compiled in said database or databases, wherein redundant repeats, doubles and/or duplicates or redundances of information and data occurring in every submission of said information and data and/or said composition by every physician and redundant repeats, doubles and duplicates or redundances of information and data occurring in submissions of information and data and/or compositions on or relating to same diagnosis, disease or disorder by physicians are scanned and processed to result in the submissions of said information and data and compositions on or relating to same diagnosis, disease or disorder having no redundant repeat, double and duplicate into and/or in said database or databases wherein said results are related, pooled and/or compiled, wherein retrieved said compositions comprise no redundant repeat, double and duplicate or information and data are repetitively viewed, manipulated, modified, edited and/or improved and used by physicians, wherein said information and data and compositions are repetitively retrieved from said database or databases and viewed, manipulated, modified, edited and/or improved and used by physicians on interactive electronic templates on viewing screens of said computers and portable communication devices, and wherein queries, choices and options and responses with regards to appointments and schedules and prescribing, ordering, fulfilling of prescriptions and records of dispensations of prescriptions and medications are sent or transmitted back and forth between physicians and pharmacists and staff people to enhance or optimize the accuracy of the recording of said information and data, to assist with and/or facilitate the medical decision makings and reduce or eliminate errors in decision makings of physicians, to improve and increase the efficiency of the processes of generating and recording health and health-care information and data, to expedite the process or processes of entering and recording of said information and data into said database or databases by physicians and to reduce the repetitive efforts of physicians' productions of same or similar said information and data and relating errors comprises:
a process of generating and submitting information and data on health, health-care and health-care services relating to diagnoses of diseases and disorders by physicians;
a process of relating information and data on health, health-care and health-care services relating to diagnoses of diseases and disorders;
a process of compiling related information and data on health, health-care and health-care services relating to diagnoses of diseases and disorders from said information and data on diagnoses, diseases, disorders, health, health-care and health-care services generated by physicians;
a process of generating compositions of related information and data on health, health-care and health-care services relating to the diagnoses of diseases and disorders from said information and data on diagnoses, diseases, disorders, health, health-care and health-care services generated by physicians;
a process of composing and/or compiling related information and data on health, health-care and health-care services relating to diagnoses of diseases and disorders from said information and data on diagnoses, diseases, disorders, health, health-care and health-care services in said database or databases;
a process of composing information and data on diagnoses of diseases and disorders and health, health-care and health-care services on and relating to said diagnoses of diseases and disorders to suit and be used by physician composers of the compositions;
a process of manipulating, modifying, editing and/or improving said compositions;
a process of manipulating, modifying, editing and/or improving said compositions by physicians;
a process of using said compositions by physicians;
a process of scanning and processing redundant repeats, doubles and/or duplicates or redundances of information and data occurring in every submission by every physician;
a process of scanning and processing redundant repeats, doubles and duplicates or redundances of information and data occurring in submissions on or relating to same diagnosis, disease or disorder into said database or databases;
a process of submitting said information and data on or relating to same diagnosis, disease or disorder having no redundant repeat, double and duplicate into said database or databases;
a process of submitting said compositions on information and data on or relating to diagnoses, diseases and disorders having no redundant repeat, double and duplicate into said database or databases;
a process of generating interactive electronic templates for generating and submitting information and data and compositions on health, health-care and health-care services relating to diagnoses of diseases and disorders by physicians;
a process of generating interactive electronic templates for repetitively viewing, manipulating, modifying, editing and/or improving information and data on health, health-care and health-care services relating to diagnoses of diseases and disorders by physicians;
a process of generating interactive electronic templates for repetitively viewing, manipulating, modifying, editing and/or improving said compositions on health, health-care and health-care services relating to diagnoses of diseases and disorders by physicians;
a process of generating interactive electronic templates for repetitive uses by physicians for viewing, manipulating, modifying, editing and/or improving information and data on health, health-care and health-care services relating to diagnoses of diseases and disorders by physicians;
a process of generating interactive electronic templates for repetitive uses of said compositions by physicians;
a process of generating interactive electronic templates for repetitive submissions of manipulated, modified, edited and/or improved information and data on health, health-care and health-care services relating to diagnoses of diseases and disorders by physicians;
a process of generating interactive electronic templates for uses and submissions of contents of said compositions to said database or databases by physicians;
a process of using said compositions by physicians to enhance or optimize the accuracy of the recording of said information and data;
a process of using said compositions by physicians to assist with and/or facilitate the medical decision makings;
a process of using said compositions by physicians to reduce or eliminate errors in decision makings of physicians;
a process of using said compositions by physicians to improve and increase the efficiency of the processes of generating and recording health and health-care information and data;
a process of using said compositions by physicians to expedite the process or processes of entering and recording of said information and data into said database or databases by physicians;
a process of relating and compiling related and compiled information and data on relating diagnoses, diseases, disorders, health, health-care and health-care services in said database or databases;
a process of retrieving related and compiled information and data on relating diagnoses, diseases, disorders, health, health-care and health-care services in said database or databases for viewing and using by physicians; and
a process of using said compositions by physicians to reduce the repetitive efforts of physicians' productions of same or similar said information and data and relating errors; and
a process of sending queries, choices and options and responses with regards to appointments and schedules and prescribing, ordering, fulfilling of prescriptions and records of dispensations of prescriptions and medications back and forth between physicians and pharmacists and staff people.

3. A method of repetitively composing information and data on health, health-care and health-care services on or relating to diagnoses, diseases and disorders by individual physicians wherein information and data composed by said individual physicians suit the needs of and are used by individual physician composers of the compositions of said information and data for manipulating, modifying, editing and improving said information and data and for submitting information and data on health, health-care and health-care services into the database or databases of computer server or servers in a network or networks of computer servers, computers and portable communication devices wherein the contents of said compositions comprising diagnoses of diseases and disorders and said information and data derived from information and data on and/or relating to diagnoses, diseases, disorders, health, health-care and health-care services are generated by physicians wherein said information and data are submitted, processed, related, stored, pooled and compiled in the database or databases of the computer server, computer servers, computer or computers in said network or networks wherein the contents of said compositions are repetitively composed and/or compiled from said submitted, processed, related and compiled information and data in said database or databases wherein said compositions are repetitively retrieved from said database or databases and the information and data and contents of said compositions are repetitively manipulated, modified, edited and/or improved by physicians and are submitted into and processed, related, stored, compiled in said database or databases, wherein redundant repeats, doubles and/or duplicates or redundances of information and data occurring in every submission of said information and data and/or said composition by every physician and redundant repeats, doubles and duplicates or redundances of information and data occurring in submissions of information and data and/or compositions on or relating to same diagnosis, disease or disorder by physicians are scanned and processed to result in the submissions of said information and data and compositions on or relating to same diagnosis, disease or disorder having no redundant repeat, double and duplicate into and/or in said database or databases wherein said results are related, pooled and/or compiled, wherein retrieved said compositions comprise no redundant repeat, double and duplicate are repetitively viewed, manipulated, modified, edited and/or improved and used by physicians, wherein said information and data and compositions are repetitively viewed, manipulated, modified, edited, improved and used by physicians on interactive electronic templates on viewing screens of said computers and portable communication devices, and wherein queries, choices and options and responses with regards to appointments and schedules and prescribing, ordering, fulfilling of prescriptions and records of dispensations of prescriptions and medications are sent or transmitted back and forth between physicians and pharmacists and staff people to enhance or optimize the accuracy of the recording of said information and data, to assist with and/or facilitate the medical decision makings and reduce or eliminate errors in decision makings of physicians, to improve and increase the efficiency of the processes of generating and recording health and health-care information and data, to expedite the process or processes of entering and recording of said information and data into said database or databases by physicians and to reduce the repetitive efforts of physicians' productions of same or similar said information and data and relating errors comprises:
a process of generating and submitting information and data on health, health-care and health-care services relating to diagnoses of diseases and disorders by physicians;
a process of relating information and data on health, health-care and health-care services relating to diagnoses of diseases and disorders;
a process of compiling related information and data on health, health-care and health-care services relating to diagnoses of diseases and disorders from said information and data on diagnoses, diseases, disorders, health, health-care and health-care services generated by physicians;
a process of generating compositions of related information and data on health, health-care and health-care services relating to the diagnoses of diseases and disorders from said information and data on diagnoses, diseases, disorders, health, health-care and health-care services generated by physicians;
a process of composing and/or compiling related information and data on health, health-care and health-care services relating to diagnoses of diseases and disorders from said information and data on diagnoses, diseases, disorders, health, health-care and health-care services in said database or databases;
a process of composing information and data on diagnoses of diseases and disorders and health, health-care and health-care services on and relating to said diagnoses of diseases and disorders to suit and be used by physician composers of the compositions;
a process of manipulating, modifying, editing and/or improving said compositions;
a process of manipulating, modifying, editing and/or improving said compositions by physicians;
a process of using said compositions by physicians;
a process of scanning and processing redundant repeats, doubles and/or duplicates or redundances of information and data occurring in every submission by every physician;
a process of scanning and processing redundant repeats, doubles and duplicates or redundances of information and data occurring in submissions on or relating to same diagnosis, disease or disorder into said database or databases;
a process of submitting said information and data on or relating to same diagnosis, disease or disorder having no redundant repeat, double and duplicate into said database or databases;
a process of submitting said compositions on information and data on or relating to diagnoses, diseases and disorders having no redundant repeat, double and duplicate into said database or databases;
a process of generating interactive electronic templates for generating and submitting information and data and compositions on health, health-care and health-care services relating to diagnoses of diseases and disorders by physicians;
a process of generating interactive electronic templates for repetitively viewing, manipulating, modifying, editing and/or improving information and data on health, health-care and health-care services relating to diagnoses of diseases and disorders by physicians;
a process of generating interactive electronic templates for repetitively viewing, manipulating, modifying, editing and/or improving said compositions on health, health-care and health-care services relating to diagnoses of diseases and disorders by physicians;
a process of generating interactive electronic templates for repetitive uses by physicians for viewing, manipulating, modifying, editing and/or improving information and data on health, health-care and health-care services relating to diagnoses of diseases and disorders by physicians;
a process of generating interactive electronic templates for repetitive uses of said compositions by physicians;
a process of generating interactive electronic templates for repetitive submissions of manipulated, modified, edited and/or improved information and data on health, health-care and health-care services relating to diagnoses of diseases and disorders by physicians;
a process of generating interactive electronic templates for uses and submissions of contents of said compositions to said database or databases by physicians;
a process of using said compositions by physicians to enhance or optimize the accuracy of the recording of said information and data;
a process of using said compositions by physicians to assist with and/or facilitate the medical decision makings;
a process of using said compositions by physicians to reduce or eliminate errors in decision makings of physicians;
a process of using said compositions by physicians to improve and increase the efficiency of the processes of generating and recording health and health-care information and data;
a process of using said compositions by physicians to expedite the process or processes of entering and recording of said information and data into said database or databases by physicians;
a process of relating and compiling related and compiled information and data on relating diagnoses, diseases, disorders, health, health-care and health-care services in said database or databases;
a process of retrieving related and compiled information and data on relating diagnoses, diseases, disorders, health, health-care and health-care services in said database or databases for viewing and using by physicians;
a process of using said compositions by physicians to reduce the repetitive efforts of physicians' productions of same or similar said information and data and relating errors; and
a process of sending queries, choices and options and responses with regards to appointments and schedules and prescribing, ordering, fulfilling of prescriptions and records of dispensations of prescriptions and medications back and forth between physicians and pharmacists and staff people.
